(19) United States
(12) Patent Application Publication
(10) Pub. No.: US 2025/0088887 A1
(43) Pub. Date: Mar. 13, 2025

(54) CHANNEL STATE INFORMATION RESOURCE CONFIGURATIONS FOR BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Junyi LI, Greentown, PA (US); Hamed PEZESHKI, San Diego, CA (US); Min Soo SIM, San Diego, CA (US)

(21) Appl. No.: 18/728,825

(22) PCT Filed: Mar. 28, 2022
(86) PCT No.: PCT/CN2022/083270

§ 371 Date: Jul. 12, 2024

(51) Int. Cl. H04W 24/10; H04B 7/06

(52) U.S. Cl. CPC H04W 24/10; H04B 7/0626

(57) ABSTRACT

Methods, systems, and devices for wireless communications are described. A user equipment (UE) may receive a channel state information (CSI) report setting that includes first and second CSI resource settings. In some examples, the first CSI resource setting and the second CSI resource setting may be associated with a set of channel measurement resources of a first serving cell and a set of beam prediction resources of a second serving cell, respectively. The UE may measure channel characteristics of the first serving cell based on a channel measurement resource of the set associated with the first CSI resource setting. Based on the measured first channel characteristics, the UE may predict channel characteristics of the second serving cell for one or more beam prediction resources of the set. As such, the UE may transmit a CSI report including an indication of the predicted channel characteristics according to the CSI report setting.

### CROSS REFERENCE

The present application is a 371 national stage filing of International PCT Application No. PCT/CN2022/083270 by LI et al. entitled “CHANNEL STATE INFORMATION RESOURCE CONFIGURATIONS FOR BEAM PREDICTION,” filed Mar. 28, 2022, which is assigned to the assignee hereof, and which is expressly incorporated by reference in its entirety herein.

### FIELD OF TECHNOLOGY

The following relates to wireless communications, including channel state information resource configurations for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel state information resource configurations for beam prediction. For example, the described techniques provide for predicting channel characteristics associated with communication beams of a serving cell supporting communications in a second frequency range (e.g., FR2) based on measured channel characteristics associated with communication beams of a serving cell supporting communications in a first frequency range (e.g., FR1) according to one or more feedback report settings.

A UE may perform cross-frequency range beam prediction based on an enhanced channel state information (CSI) report setting. For example, the UE may receive control signaling including a CSI report setting configured in the first frequency range or the second frequency range. Based on receiving the CSI report setting, the UE may measure one or more channel characteristics associated with the first set of communication beams (e.g., communications in the first frequency range) based on a set of channel measurement resources indicated in the CSI report setting provided by a network entity. The UE may predict one or more channel characteristics associated with the second set of communication beams (e.g., communications in the second frequency range) based on a set of beam prediction resources indicated in the CSI report setting. As such, the UE may transmit, via the first frequency range or the second frequency range, a feedback report (e.g., CSI report) including the measured channel characteristics and the predicted channel characteristics based on the CSI report setting.

A method for wireless communication at a user equipment (UE) is described. The method may include receiving a control message indicating a channel state information (CSI) report setting that includes a first CSI resource setting and a second CSI resource setting, where the first CSI resource setting is associated with a set of channel measurement resources of a first serving cell and the second CSI resource setting is associated with a set of beam prediction resources of a second serving cell, measuring first channel characteristics of the first serving cell based on one or more channel measurement resources of the set of channel measurement resources associated with the first CSI resource setting, predicting, based on measuring the first channel characteristics, second channel characteristics of the second serving cell that are associated with one or more beam prediction resources of the set of beam prediction resources, and transmitting a CSI report in accordance with the CSI report setting, the CSI report including an indication of the second channel characteristics.

An apparatus for wireless communication at a UE is described. The apparatus may include a processor, memory coupled with the processor, and instructions stored in the memory. The instructions may be executable by the processor to cause the apparatus to receive a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell, measure first channel characteristics of the first serving cell based on one or more channel measurement resources of the set of channel measurement resources associated with the first CSI resource setting, predict, based on measuring the first channel characteristics, second channel characteristics of the second serving cell that are associated with one or more beam prediction resources of the set of beam prediction resources, and transmit a CSI report in accordance with the CSI report setting, the CSI report including an indication of the second channel characteristics.

Another apparatus for wireless communication at a UE is described. The apparatus may include means for receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell, means for measuring first channel characteristics of the first serving cell based on one or more channel measurement resources of the set of channel measurement resources associated with the first CSI resource setting, means for predicting, based on measuring the first channel characteristics, second channel characteristics of the second serving cell that are associated with one or more beam prediction resources of the set of beam prediction resources, and means for transmitting a CSI report in accordance with the CSI report setting, the CSI report including an indication of the second channel characteristics.

A non-transitory computer-readable medium storing code for wireless communication at a UE is described. The code may include instructions executable by a processor to receive a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell, measure first channel characteristics of the first serving cell based on one or more channel measurement resources of the set of channel measurement resources associated with the first CSI resource setting, predict, based on measuring the first channel characteristics, second channel characteristics of the second serving cell that are associated with one or more beam prediction resources of the set of beam prediction resources, and transmit a CSI report in accordance with the CSI report setting, the CSI report including an indication of the second channel characteristics.

Some examples of the method, apparatuses, and non-transitory computer-readable medium described herein may further include operations, features, means, or instructions for determining one or more associations between the set of beam prediction resources of the second serving cell and the set of channel measurement resources of the first serving cell or other channel measurement resources of multiple serving cells, where predicting the second channel characteristics may be based on the one or more associations and one or more channel measurement resources from the set of channel measurement resources or the other channel measurement resources, or both.

In some examples of the method, apparatuses, and non-transitory computer-readable medium described herein, a first association of the one or more associations includes an association between an antenna port associated with a beam prediction resource and a set of antenna ports for a channel measurement resource of the set of channel measurement resources.

In some examples of the method, apparatuses, and non-transitory computer-readable medium described herein, predicting the second channel characteristics may include operations, features, means, or instructions for determining, based on the first association, respective channel characteristics for each of two or more groups of antenna ports across respective channel measurement resources from the set of channel measurement resources or the other channel measurement resources, or both, where the respective channel characteristics include at least a power delay profile, an angle of arrival, a channel or any combination thereof and determining the second channel characteristics of the second serving cell based on the respective channel characteristics of the two or more groups of antenna ports, where the indication of the second channel characteristics includes a rank indicator, a channel quality parameter, a precoding matrix indicator, or any combination thereof.

In some examples of the method, apparatuses, and non-transitory computer-readable medium described herein, a second association of the one or more associations includes an association between a polarization associated with the second channel characteristics and a group of antenna ports for a channel measurement resource of the set of channel measurement resources.

In some examples of the method, apparatuses, and non-transitory computer-readable medium described herein, predicting the second channel characteristics may include operations, features, means, or instructions for identifying a first assumption that a first group of antenna ports of a first channel measurement resource from the set of channel measurement resources may be associated with a first antenna port based on a first polarization, identifying a second assumption that a second group of antenna ports of a second channel measurement resource from the set of channel measurement resources may be associated with a second antenna port based on a second polarization, and determining the second channel characteristics of the second serving cell based on the first assumption and the second assumption, where the indication of the second channel characteristics includes a rank indicator, a channel quality parameter, a precoding matrix indicator, or any combination thereof.

In some examples of the method, apparatuses, and non-transitory computer-readable medium described herein, a third association of the one or more associations includes an association between one or more antenna configurations for the set of beam prediction resources, one or more antenna configurations for the set of channel measurement resources, or any combination thereof.

In some examples of the method, apparatuses, and non-transitory computer-readable medium described herein, predicting the second channel characteristics may include operations, features, means, or instructions for determining the third association based on one or more cell-common configurations.

In some examples of the method, apparatuses, and non-transitory computer-readable medium described herein, a fourth association of the one or more associations includes an association between a number of antenna elements and an antenna port associated with the set of beam prediction resources.

In some examples of the method, apparatuses, and non-transitory computer-readable medium described herein, the CSI report setting, the first CSI resource setting, the second CSI resource setting, or any combination thereof, includes an indication of the one or more associations, where determining the one or more associations may be based on the indication of the one or more associations and each association of the one or more associations may be associated with the one or more channel measurement resources of the set of channel measurement resources or a number of antenna ports for the set of channel measurement resources.

In some examples of the method, apparatuses, and non-transitory computer-readable medium described herein, predicting the second channel characteristics may include operations, features, means, or instructions for predicting the second channel characteristics based on an output of one or more machine learning algorithms, where an input of the one or more machine learning algorithms includes information that may be based on the one or more associations.

In some examples of the method, apparatuses, and non-transitory computer-readable medium described herein, the one or more machine learning algorithms include a multi-stage machine learning algorithm and a first machine learning algorithm of the one or more machine learning algorithms generates an input for a second machine learning algorithm of the one or more machine learning algorithms that predicts the second channel characteristics, an input of the first machine learning algorithm being based on the one or more associations.

In some examples of the method, apparatuses, and non-transitory computer-readable medium described herein, the input of the one or more machine learning algorithms may be based on features estimated from the one or more associations.

Some examples of the method, apparatuses, and non-transitory computer-readable medium described herein may further include operations, features, means, or instructions for receiving, within the CSI report setting, an indication of a cell identifier of the second serving cell, where a CSI resource setting identifier for the set of beam prediction resources may be associated with a CSI measurement setting of the second serving cell.

Some examples of the method, apparatuses, and non-transitory computer-readable medium described herein may further include operations, features, means, or instructions for receiving, within the CSI report setting, an indication of a cell identifier of the first serving cell, where a CSI resource setting identifier for the set of channel measurement resources may be associated with a CSI measurement setting of the first serving cell.

Some examples of the method, apparatuses, and non-transitory computer-readable medium described herein may further include operations, features, means, or instructions for determining that a bandwidth part associated with the set of beam prediction resources associated with the second CSI resource setting includes a dormant bandwidth part within the second serving cell, the second channel characteristics being predicted based on the dormant bandwidth part, where the CSI report may be transmitted via the first serving cell.

Some examples of the method, apparatuses, and non-transitory computer-readable medium described herein may further include operations, features, means, or instructions for determining that a bandwidth part associated with the set of channel measurement resources associated with the first CSI resource setting includes a dormant bandwidth part within the first serving cell, the first channel characteristics being measured based on the dormant bandwidth part, where the CSI report may be transmitted via the second serving cell.

Some examples of the method, apparatuses, and non-transitory computer-readable medium described herein may further include operations, features, means, or instructions for determining that a first number of resources of the first CSI resource setting may be associated with a second number of resources of the second CSI resource setting, where the second channel characteristics may be predicted based on the first number of resources.

In some examples of the method, apparatuses, and non-transitory computer-readable medium described herein, the CSI report setting includes an indication that the first number of resources may be associated with the second number of resources and the determination may be based on the indication that the first number of resources may be associated with the second number of resources.

Some examples of the method, apparatuses, and non-transitory computer-readable medium described herein may further include operations, features, means, or instructions for receiving a message indicating a setting of one or more models for predicting the second channel characteristics, where the one or more models may be based on the first number of resources of the first CSI resource setting being associated with the second number of resources of the second CSI resource setting, where predicting the second channel characteristics may be based on an output of the one or more models.

Some examples of the method, apparatuses, and non-transitory computer-readable medium described herein may further include operations, features, means, or instructions for determining a frequency location of a synchronization signal block of the second serving cell based on the second CSI resource setting, where the frequency location of the synchronization signal block may be within an active bandwidth part of the second serving cell or outside of the active bandwidth part of the second serving cell.

Some examples of the method, apparatuses, and non-transitory computer-readable medium described herein may further include operations, features, means, or instructions for determining a frequency location of a synchronization signal block of the first serving cell based on the first CSI resource setting, where the frequency location of the synchronization signal block may be within an active bandwidth part of the first serving cell or outside of the active bandwidth part of the first serving cell.

In some examples of the method, apparatuses, and non-transitory computer-readable medium described herein, receiving the control message may include operations, features, means, or instructions for receiving the control message indicating the CSI report setting from the first serving cell or from the second serving cell.

In some examples of the method, apparatuses, and non-transitory computer-readable medium described herein, the indication of the second channel characteristics includes a synchronization signal block resource indicator, a CSI reference signal resource indicator, a reference signal receive power, a single-to-noise ratio, a rank indicator, a channel quality indicator, a precoding matrix indicator, or any combination thereof.

In some examples of the method, apparatuses, and non-transitory computer-readable medium described herein, the set of channel measurement resources or the set of beam prediction resources, or both, may be associated with a set of CSI reference signal resources or a set of synchronization signal block resources, or both.

A method for wireless communication at a network entity is described. The method may include outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell and receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

An apparatus for wireless communication at a network entity is described. The apparatus may include a processor, memory coupled with the processor, and instructions stored in the memory. The instructions may be executable by the processor to cause the apparatus to output a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell and receive a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

Another apparatus for wireless communication at a network entity is described. The apparatus may include means for outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell and means for receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

A non-transitory computer-readable medium storing code for wireless communication at a network entity is described. The code may include instructions executable by a processor to output a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell and receive a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

In some examples of the method, apparatuses, and non-transitory computer-readable medium described herein, the predicted channel characteristics may be based on one or more associations between the set of beam prediction resources and the set of channel measurement resources.

Some examples of the method, apparatuses, and non-transitory computer-readable medium described herein may further include operations, features, means, or instructions for outputting, within the CSI report setting, an indication of a cell identifier of the first serving cell or a cell identifier of the second serving cell, where a CSI resource setting identifier for the set of beam prediction resources may be associated with a CSI measurement setting of the first serving cell or a CSI measurement setting of the second serving cell.

### BRIEF DESCRIPTION OF THE DRAWINGS

FIG. 1 illustrates an example of a wireless communications system that supports channel state information resource configurations for beam prediction in accordance with one or more aspects of the present disclosure.

FIG. 2 illustrates an example of wireless communications system that support channel state information resource configurations for beam prediction in accordance with one or more aspects of the present disclosure.

FIGS. 3A and 3B illustrate examples of CSI report settings that support channel state information resource configurations for beam prediction in accordance with one or more aspects of the present disclosure.

FIGS. 4 and 5 illustrate examples of wireless communications systems that support channel state information resource configurations for beam prediction in accordance with one or more aspects of the present disclosure.

FIG. 6 illustrates an example of a process flow in a system that supports channel state information resource configurations for beam prediction in accordance with one or more aspects of the present disclosure.

FIGS. 7 and 8 show block diagrams of devices that support channel state information resource configurations for beam prediction in accordance with one or more aspects of the present disclosure.

FIG. 9 shows a block diagram of a communications manager that supports channel state information resource configurations for beam prediction in accordance with one or more aspects of the present disclosure.

FIG. 10 shows a diagram of a system including a device that supports channel state information resource configurations for beam prediction in accordance with one or more aspects of the present disclosure.

FIGS. 11 and 12 show block diagrams of devices that support channel state information resource configurations for beam prediction in accordance with one or more aspects of the present disclosure.

FIG. 13 shows a block diagram of a communications manager that supports channel state information resource configurations for beam prediction in accordance with one or more aspects of the present disclosure.

FIG. 14 shows a diagram of a system including a device that supports channel state information resource configurations for beam prediction in accordance with one or more aspects of the present disclosure.

FIGS. 15 through 19 show flowcharts illustrating methods that support channel state information resource configurations for beam prediction in accordance with one or more aspects of the present disclosure.

### DETAILED DESCRIPTION

One or more network entities may support a number of cells for serving a user equipment (UE). For example, one or more aspects of a network entity may support a first serving cell for communications with the UE in a first frequency range (e.g., FR1) or a second frequency range (e.g., FR2) and one or more aspects of the network entity may support a second serving cell for communications with the UE in the second frequency range or the first frequency range. Communications in the first frequency range may be associated with a first set of communication beams and communications in the second frequency range may be associated with a second set of communication beams. In some examples, beam management (e.g., selection, reselection, beam failure reselection) may be performed based on channel characteristics associated with the first set of communication beams, the second set of communication beams, or both. That is, communications between the UE and the network entity may be performed based on channel characteristics associated with communications in the first frequency range, the second frequency range, or both. In some examples, the UE may predict one or more channel characteristics for communications in the second frequency range based on channel characteristics associated with communications the first frequency range. However, some methods of cross frequency range prediction may involve receiving multiple CSI report settings (e.g., corresponding to each frequency range), which may be inefficient and result in increased signaling overhead.

A UE may perform cross-frequency range beam prediction based on an enhanced CSI report setting (e.g., a CSI report configuration). For example, the UE may receive control signaling including a single CSI report setting configured in the first frequency range or the second frequency range (e.g., within the first serving cell or the second serving cell). The single CSI report setting may include a first CSI resource setting (e.g., a first CSI resource configuration associated with the first frequency range) for a set of channel measurement resources and a second CSI resource setting (e.g., a second CSI resource configuration associated with the second frequency range) for a set of beam prediction resources. Based on receiving the CSI report setting, the UE may measure one or more channel characteristics associated with the first set of communication beams (e.g., communications in the first frequency range) based on the set of channel measurement resources indicated in the CSI report setting provided by a network entity. The UE may predict one or more channel characteristics associated with the second set of communication beams (e.g., communications in the second frequency range) based on the set of beam prediction resources indicated in the CSI report setting. As such, the UE may transmit, via the first frequency range or the second frequency range, a feedback report (e.g., CSI report) including the measured channel characteristics and the predicted channel characteristics based on the CSI report setting.

In some examples, the predicted channel characteristics may be determined by the UE based on an association of the beam prediction resources with the channel measurement resources associated with the first frequency range or with one or more other channel measurement resources of multiple serving cells. In some examples, the predicted channel characteristics may be output by a model (e.g., a machine learning model or algorithm) having one or more inputs associated with measured channel characteristics of communications in the first frequency range.

Aspects of the disclosure are initially described in the context of wireless communications systems. Additional aspects of the disclosure are described in the context of feedback report setting and a process flow. Aspects of the disclosure are further illustrated by and described with reference to apparatus diagrams, system diagrams, and flowcharts that relate to channel state information resource configurations for beam prediction.

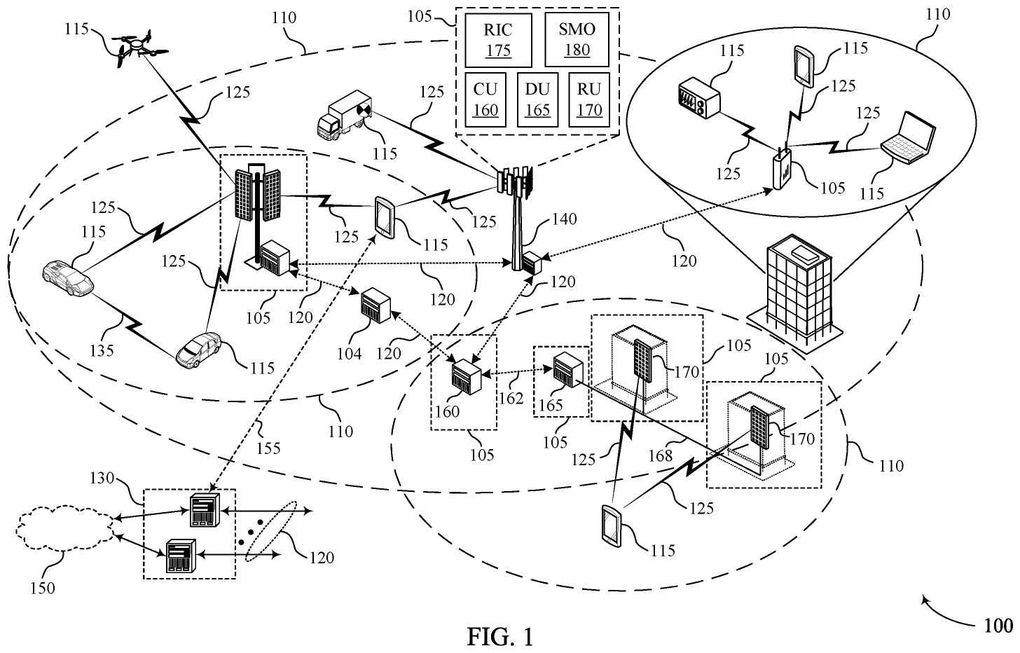

FIG. 1 illustrates an example of a wireless communications system 100 that supports channel state information resource configurations for beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel state information resource configurations for beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In the wireless communications system 100, a UE 115 may communicate with a network entity 105 that may support a first serving cell for communications in a first frequency range (e.g., FR1 or FR2) and a second serving cell in a second frequency range (e.g., FR2 or FR1). The UE 115 and the network entity 105 may communicate using directional communication beams (e.g., beamformed communications), which may be periodically measured and selected for communication quality.

A UE 115 may predict channel characteristics associated with communication beams of a serving cell supporting communications in the second frequency range (e.g., FR2) based on measured channel characteristics associated with communication beams of a serving cell supporting communications in the first frequency range (e.g., FR1) according to one or more feedback report settings. The UE 115 may perform cross-frequency range beam prediction based on an enhanced CSI report setting. For example, the UE 115 may receive control signaling including a CSI report setting configured in the first frequency range or the second frequency range. In some examples, the CSI report setting may include CSI resource configurations for each of the at least two serving cells. The CSI resource configurations may indicate resources for measuring or predicting channel conditions or characteristics associated with communications in the respective serving cell (e.g., channel conditions for one or more communication beams supported by the respective serving cell. Based on receiving the CSI report setting, the UE 115 may measure one or more channel characteristics associated with the first set of communication beams (e.g., communications in the first frequency range) based on a set of channel measurement resources (CMRs) (e.g., a channel measurement resource set) indicated in the CSI report setting. The UE 115 may predict one or more channel characteristics associated with the second set of communication beams (e.g., communications in the second frequency range) based on a set of beam prediction resources (BPRs) (e.g., a beam prediction resource set) indicated in the CSI report setting. As such, the UE 115 may transmit, via the first frequency range or the second frequency range, a feedback report (e.g., CSI report) including the measured channel characteristics and the predicted channel characteristics based on the CSI report setting.

For example, the UE 115 may receive, via a first frequency range or a second frequency range, a control message indicating a CSI report setting (e.g., a CSI report configuration) that includes a first CSI resource setting (e.g., a first CSI resource configuration) and a second CSI resource setting (e.g., a second CSI resource configuration), where the first CSI resource setting is associated with a set of channel measurement resources of a first serving cell and the second CSI resource setting is associated with a set of beam prediction resources of a second serving cell. The set of channel measurement resources or the set of beam prediction resources, or both, may be based on CSI-RS resource or synchronization signal block (SSB) resources. In some examples, the first serving cell may be associated with a first frequency range and the second serving cell may be associated with communications in the second frequency range. The UE 115 may measure first channel characteristics of the first serving cell based on one or more channel measurement resources of the set of channel measurement resources associated with the first CSI resource setting. Further, the UE 115 may predict, based on measuring the first channel characteristics, second channel characteristics of the second serving cell that are associated with one or more beam prediction resources of the set of beam prediction resources. The UE 115 may transmit (e.g., to a network entity 105 supporting the first serving cell, the second serving cell or both), a CSI report in accordance with the CSI report setting. In some examples, the CSI report may include an indication of the second channel characteristics. In some cases, the UE 115 may determine one or more associations between the set of beam prediction resources of the second serving cell and the set of channel measurement resources of the first serving cell or other channel measurement resources of multiple serving cells in which case predicting the second channel characteristics may be based on the one or more associations and one or more channel measurement resources from the set of channel measurement resources or the other channel measurement resources, or both.

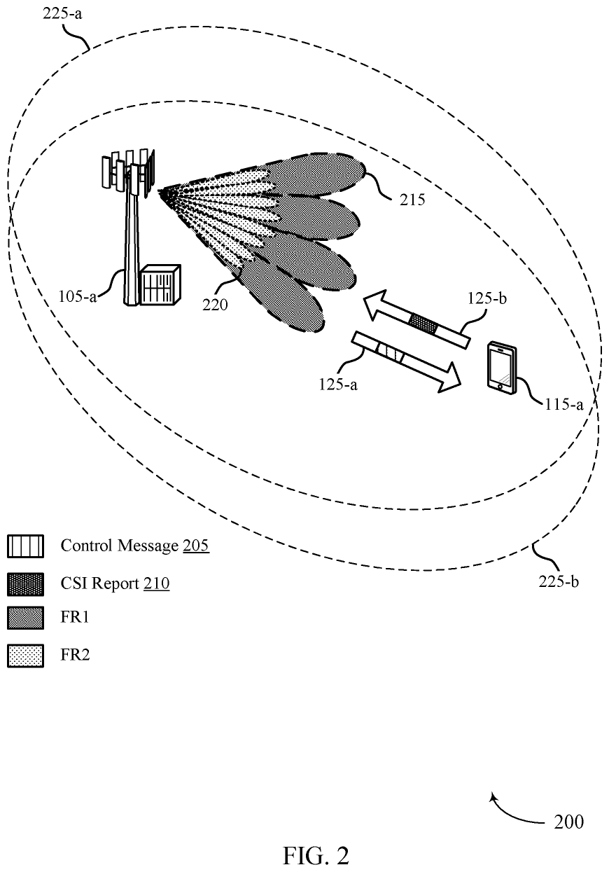

FIG. 2 illustrates an example of a wireless communications system 200 that supports channel state information resource configurations for beam prediction in accordance with one or more aspects of the present disclosure. In some examples, wireless communications system 200 may implement aspects of wireless communications system 100. For instance, wireless communications system 200 includes a UE 115-a, and a network entity 105-a, which may be examples of the corresponding devices described with reference to FIG. 1. Additionally, or alternatively, the UE 115-a may be an example of a CPE, a relay node, a repeater, a router, an IAB node, or the like. Similarly, the network entity 105-a may be an example of a backhaul node, an IAB node, or the like. Thus, although aspects of the present disclosure are described with reference to a UE 115 and network entities 105, it is understood that the described techniques may be performed by a wireless device different from a UE 115 and network entities 105.

The wireless communications system 200 may further include a first serving cell 225-a and a second serving cell 225-b. In some examples, the first serving cell 225-a and the second serving cell 225-b may each be supported by one or more aspects of the network entity 105-a. In some other examples, the first serving cell 225-a may be supported by one or more aspects of the network entity 105-a and the second serving cell 225-b may be supported by one or more aspects of a second network entity 105. It is to be understood that while the wireless communications system 200 depicts that first serving cell 225-a and second serving cell 225-b are supported by the network entity 105-a, the examples is intended to be non-limiting and the first serving cell 225-a and second serving cell 225-b may be supported by one or more network entities.

In some examples, the first serving cell 225-a may be associated with (e.g., may support) one or more FR1 communication beams 215 and the second serving cell 225-b may be associated with (e.g., may support) one or more FR2 communication beams 220. The UE 115-a may communicate with the first serving cell 225-a via FR1 communication beams 215 or the second serving cell 225-b via FR2 communication beams 220, or both, via the network entity 105-a.

In some examples, the UE 115-a may perform channel measurement for communications via the FR1 communication beams 215 to predict channel quality characteristics for communications via the FR2 communication beams 220 as part of one or more beamforming operations to reduce latency, increase scheduling flexibility, and reduce power consumption. In some examples, the UE 115-a may support one or more machine-learning models to perform channel quality predications where model inputs may include less frequently measured FR2 communication beams 220 together with signals received from the network entity 105-a via one or more of the FR1 communication beams 215. In some examples, multiple FR1 transmission reception points or antenna ports (e.g., communication beams) may reduce uncertainty caused by power delay profile (PDP) impairment between FR1 communications and FR2 communications.

As such, the UE 115-a may report predicted channel characteristics to the network entity 105-a via a communication link 125-b in a CSI report 210 because, in some examples, calculating and reporting all raw measurements for FR1 communications may consume relatively large amounts of energy.

Some aspects of CSI reporting configurations may be inefficient. For example, the UE 115-a may identify channel measurement resources defined for the first serving cell 225-a in FR1 and beam prediction resources defined for the second serving cell 225-b in FR2, and may jointly use the resources to report the CSI associated with the beam prediction resources. However, such aspects may not be effectively supported by some wireless communications systems. For example, configurations associated with different frequency ranges may be defined in different (e.g., separate) serving cell configurations (e.g., ServingCellConfig) including a first serving cell configuration for the first serving cell 225-a and a second serving cell configuration for the second serving cell 225-b. In some examples, the different serving cell configurations may include respective CC/BWP parameters, CSI report settings, CSI resource settings, and CSI resources (e.g., CSI-RS resources), or the like. In some examples, CSI report settings for a serving cell may be applicable to the CSI resource configurations and CSI resources defined for the respective serving cell 225, which may be impractical or inefficient when using CSI resources defined for different serving cells to be jointly used by a CSI report setting defined in one of the serving cells.

Thus, signaling enhancement for a CSI report setting and associated linkages or associations between different CSI resources (e.g., CMRs, BPRs) may be defined for different serving cells to better support cross-frequency beam prediction.

For example, the network entity 105-a may transmit or output a control message 205 via a communication link 125-a indicating a CSI report setting that comprises a first CSI resource setting for CMRs associated with the first serving cell 225-a and a second CSI resource setting for BPRs associated with the second serving cell 225-b. In some examples, the first CSI resource setting (e.g., configuration) may indicate a set of CMRs for measuring channel characteristics of the first serving cell 225-a and the second CSI resource setting (e.g., configuration) may indicate a set of BPRs for predicting channel characteristics of a second serving cell.

The UE 115-a may measure channel characteristics of the first serving cell 225-a (e.g., associated with one or more of the communication beams 405) based on one or more CMRs of the set of CMRs associated with the first CSI resource setting. The UE 115-a may predict channel characteristics for the second serving cell 225-b (e.g., associated with one or more of the communication beams 410) that are associated with one or more BPRs of the set of BPRs. Based on the measuring and predicting, the UE 115-a may transmit a CSI report 210 to the network entity 105-a according to the CSI report setting signaled in the control signaling 205. The CSI report 210 may include the measure channel characteristics and the predicted channel characteristics. As such, the UE 115-a transmit a CSI report 210 including predicted channel characteristics for the second serving cell 225-b and measured channel characteristics for the first serving cell 225-a based on receiving a single CSI report setting.

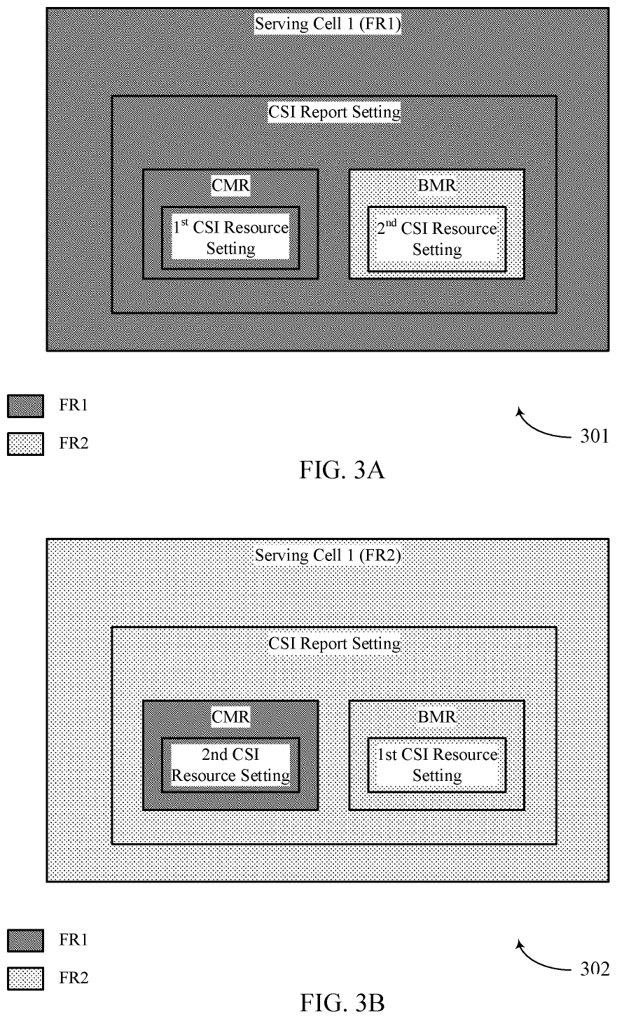

FIG. 3A illustrates an example of a CSI report setting 301 that supports channel state information resource configurations for beam prediction in accordance with one or more aspects of the present disclosure. The CSI report setting 301 may be an example of a CSI report setting as described with respect to FIG. 2 and may implement or be implemented by aspects as described with references to wireless communications systems 100 or 200, or both.

The CSI report setting 301 may be configured within a first serving cell supporting communications via a first frequency range (e.g., FR1). The CSI report setting 301 may include a first CSI resource configuration for communications supported by the first serving cell and may define a number of CMRs for measuring channel characteristics of communications supported by the first serving cell via the first frequency range. The CSI report setting may further include a second CSI resource configuration for a second serving cell (e.g., defined with the second serving cell) supporting communications in a second frequency range (e.g., FR2). The second CSI resource configuration may define a number of BPRs for predicting channel characteristics of communications supported by the second serving cell via the second frequency range. In some examples, the prediction results of the BPR may be based on one or more measurements performed on the CMR. In some examples, channel characteristics may include one or more of synchronization signal (SS)/physical broadcast channel (PBCH) resource block indicator (SSBRI), CSI-RS resource indicator (CRI), layer 1 reference signal received power (L1-RSRP), layer 1 signal to interference noise ratio (L1-SINR), rank indication (RI), channel quality index (CQI), or precoding matrix indicator (PMI), among other examples.

A UE (e.g., a UE 115 as described with reference to FIG. 1) may be configured via the CSI report setting 301 to transmit a CSI report via a first frequency range (e.g., FR1). For example, the UE may be configured with a CSI report configuration (e.g., CSI-ReportConfig), or a CSI report setting while operating within a first serving cell (e.g., connected to a network entity supporting communications via the first serving cell). In some examples, a first CSI resource configuration (e.g., a first CSI-ResourceConfig) may be associated with communications with the first serving cell (e.g., via FR1) and may be associated with one or more channel measurement resources (e.g., resourcesforChannelMeasurement) configured or indicated by the CSI report setting. In some examples, a second CSI resource configuration (e.g., a second CSI-ResourceConfig) may be associated with communications with a second serving cell (e.g., via FR2) and may be associated with one or more beam prediction resources (e.g., resourcesForPredictedBeams, BPRs) configured or indicated by the CSI report setting. In such examples, the UE may transmit a CSI report according to the CSI report setting which may indicate that the report is to include one or more measurements of SSBRI, CRI, L1-RSRP, L1-SINR, RI, CQI, or PMI of the resources (e.g., CSI-RS/SSB resources) associated with the second CSI resource configuration. In some examples, the one or more measurements of SSBRI, CRI, L1-RSRP, L1-SINR, RI, CQI, or PMI may be predicted measurements based on the first CSI resource configuration (e.g., based on one or more measurements of SSBRI, CRI, L1-RSRP, L1-SINR, RI, CQI, or PMI of the resources (e.g., CSI-RS/synchronization signal block (SSB) resources, CMR) associated with the first CSI resource configuration. Additionally, or alternatively, beam blockage incidents with respect to the resources (e.g., CSI-RS/SSB resources) associated with the second CSI resource configuration may be predicted based on the first CSI resource configuration.

The CSI report setting (e.g., CSI-ReportConfig) within the first serving cell may include a cell ID of the second serving cell. For example, the cell ID (e.g., CSI-ResourceConfigID) of the second CSI resource configuration (e.g., CSI-ResourceConfig) with respect to BPR (e.g., resourcesForPredictedBeams) may be associated with a CSI measurement configuration (e.g., CSI-MeasConfig) of the second serving cell.

In some examples, the channel characteristics may be measured based on a dormant BWP. Additionally, or alternatively, channel characteristics may be reported for a dormant BWP. That is, when channel characteristics are reported via the first frequency range, a BWP associated with the second CSI resource configuration (e.g., CSI-ResourceConfig) for the BPRs (e.g., resourcesForPredictedBeams) may be a dormant BWP within the second Serving Cell. For example, the UE may measure channel characteristics for the first frequency range and may report CSI via the first frequency range (e.g., FR1) including the predicted channel characteristics for the communication beams associated with the second serving cell (e.g., FR2 beams), while traffic in the second serving cell (e.g., FR2 traffic) is dormant (e.g., associated with a dormant status indicator). That is, in some examples, the UE may report CSI for FR2 traffic supported by the second serving cell when the traffic status for FR2 is dormant.

In some examples, there may be a linkage or an association between the first CSI resource configuration and the second CSI resource configuration. For example, a first number of CSI-RS resources or SSB resources or CSI-RS ports identified by the first CSI resource configuration may be linked or associated with a second number of CSI-RS resources or SSB resources or CSI-RS ports identified by the second CSI resource configuration such that the UE may determine the predicted channel characteristics (e.g., L1-RSRP/SINR) associated with the second number of CSI-RS resources or SSB resources or CSI-RS ports based on the first number of CSI-RS resources or SSB resources or CSI-RS ports.

The second CSI resource configuration may include CSI-RS resources, SSB resources, or both, where configured SSBs may be outside of an active BWP of the first frequency range. In some examples, SSBs for measuring channel characteristics of the second serving cell may be outside of an active BWP of the second frequency range. For example, one or more SSBs may be configured with respect to the second CSI resource configuration and the UE may determine (e.g., expect) that the SSB is outside the active BWP of the second serving cell (e.g., at a time when the CMRs are measured or when the CSI report is transmitted). That is, in some examples, the UE may expect that the SSB is outside the active BWP of the second serving cell at least during measurement of the CMRs or during transmission of the CSI report, or both.

FIG. 3B illustrates an example of a CSI report setting 302 that supports channel state information resource configurations for beam prediction in accordance with one or more aspects of the present disclosure. The CSI report setting 302 may be an example of a CSI report setting as described with respect to FIG. 2 and may implement or be implemented by aspects as described with references to wireless communications systems 100 or 200, or both.

The CSI report setting 302 may be configured within a first serving cell supporting communications via a second frequency range (e.g., FR2). The CSI report setting 302 may include a first CSI resource configuration for communications supported by the first serving cell and may define a number of BPR for predicting channel characteristics of communications supported by the first serving cell via the second frequency range. The CSI report setting may further include a second CSI resource configuration for a second serving cell (e.g., defined with the second serving cell) supporting communications in a first frequency range (e.g., FR1). The second CSI resource configuration may define a number of CMR for measuring channel characteristics of communications supported by the second serving cell via the first frequency range. In some examples, the prediction results of the BPR may be based on one or more measurements performed on the CMR. In some examples, channel characteristics may include one or more of SSBRI, CRI, L1-RSRP, L1-SINR, RI, CQI, or PMI.

In some examples, a UE (e.g., a UE 115 as described with reference to FIG. 1) may be configured via the CSI report setting 302 to transmit a CSI report via a second frequency range (e.g., FR2). For example, the UE may be configured with a CSI report configuration (e.g., CSI-ReportConfig), or a CSI report setting while operating within a first serving cell (e.g., connected to a network entity supporting communications via the first serving cell). In some examples, a first CSI resource configuration (e.g., a first CSI-ResourceConfig) may be associated with communications with the first serving cell (e.g., via FR2) and may be associated with one or more beam prediction resources (e.g., resourcesForPredictedBeams) configured or indicated by the CSI report setting. In some examples, a second CSI resource configuration (e.g., a second CSI-ResourceConfig) may be associated with communications with a second serving cell (e.g., via FR1) and may be associated with one or more channel measurement resources (e.g., resourcesForChannelMeasurement, CMRs) configured or indicated by the CSI report setting. In such examples, the UE may transmit a CSI report according to the CSI report setting which may indicate that the report is to include one or more measurements of SSBRI, CRI, L1-RSRP, L1-SINR, RI, CQI, or PMI of the resources (e.g., CSI-RS/SSB resources) associated with the first CSI resource configuration. In some examples, the one or more measurements of SSBRI, CRI, L1-RSRP, L1-SINR, RI, CQI, or PMI may be predicted measurements based on the second CSI resource configuration (e.g., based on one or more measurements of SSBRI, CRI, L1-RSRP, L1-SINR, RI, CQI, or PMI of the resources (e.g., CSI-RS/SSB resources, CMR) associated with the second CSI resource configuration). Additionally, or alternatively, beam blockage incidents with respect to the resources (e.g., CSI-RS/SSB resources) associated with the first CSI resource configuration may be predicted based on the second CSI resource configuration.

The CSI report setting (e.g., CSI-ReportConfig) within the first serving cell may include a cell ID of the second serving cell. For example, the cell ID (e.g., CSI-ResourceConfigID) of the second CSI resource configuration (e.g., CSI-ResourceConfig) with respect to CMR (e.g., resourcesForChannelMeasurement) may be associated with a CSI measurement configuration (e.g., CSI-MeasConfig) of the second serving cell.

In some cases, channel characteristics may be measured on a dormant BWP. Additionally, or alternatively, channel characteristics may be reported for a dormant BWP. That is, when channel characteristics are reported via the second frequency range, a BWP associated with the second CSI resource configuration (e.g., CSI-ResourceConfig) for the CMRs (e.g., resourcesForChannelMeasurement) may be a dormant BWP within the first serving cell. For example, the UE may measure channel characteristics for the first frequency range (e.g., FR1) and may transmit the CSI report via the second frequency range (e.g., FR2) including the predicted channel characteristics for the communication beams associated with the second serving cell (e.g., FR2 beams), while traffic in the first serving cell (e.g., FR1 traffic) is dormant (e.g., associated with a dormant status indicator). That is, in some examples, the UE may report predicted CSI for FR2 communication beams supported by the second serving cell based on channel measurements performed for FR1 traffic even when the traffic status is dormant. that is dormant FR2.

The second CSI resource configuration may include CSI-RS resources, SSB resources, or both, where configured SSBs may be outside of an active BWP of the first frequency range. In some examples, SSBs for measuring channel characteristics of the second serving cell may be outside of an active BWP of the second frequency range. For example, one or more SSBs may be configured with respect to the second CSI resource configuration and the UE may not determine that the SSB is outside the active BWP of the second serving cell (e.g., at a time when the CMRs are measured). That is, in some examples, the UE may not expect that the SSB is outside the active BWP of the second serving cell at least during measurement of the CMRs.

In some examples, there may be a linkage or an association between the first CSI resource configuration and the second CSI resource configuration. For example, a first number of CSI-RS resources or SSB resources or CSI-RS ports identified by the first CSI resource configuration may be linked or associated with a second number of CSI-RS resources or SSB resources or CSI-RS ports identified by the second CSI resource configuration such that the UE may determine the predicted channel characteristics (e.g., L1-RSRP/SINR) associated with the first number of CSI-RS resources or SSB resources or CSI-RS ports based on the second number of CSI-RS resources or SSB resources or CSI-RS ports.

In the example CSI report settings 301 and 302 the ID of the CSI-Resources identified from the second CSI-ResourceConfig may be associated with the CSI measurement configuration (e.g., CSI-MeasConfig) of the second serving cell (e.g., associated with FR2 or FR1 in the examples of CSI report settings 301 and 302, respectively). In some examples, a BWP ID may be identified from the second CSI-ResourceConfig and may be associated with the CSI measurement configuration (e.g., CSI-MeasConfig) of the second serving cell (e.g., associated with FR2 or FR1 in the examples of CSI report settings 301 and 302, respectively).

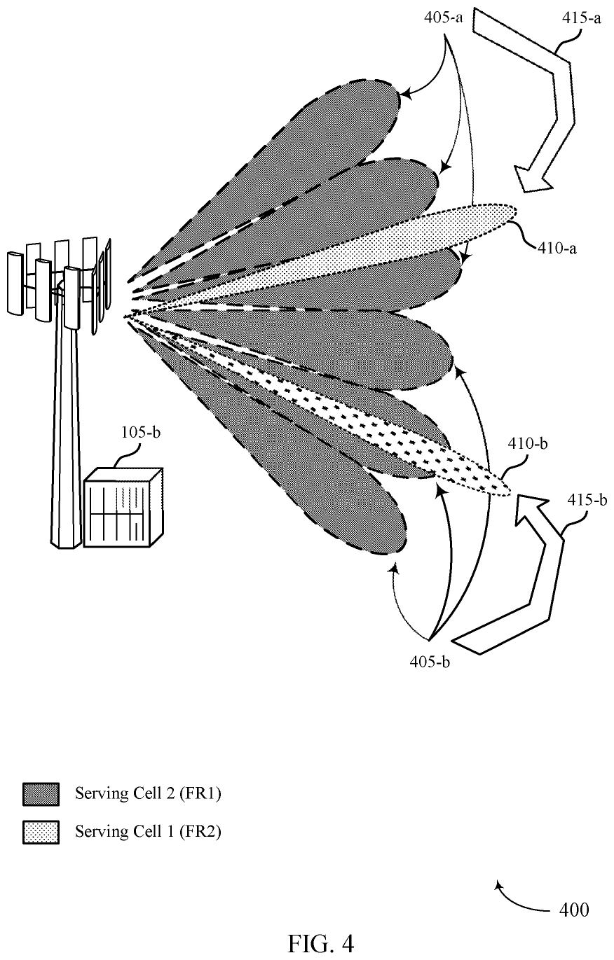

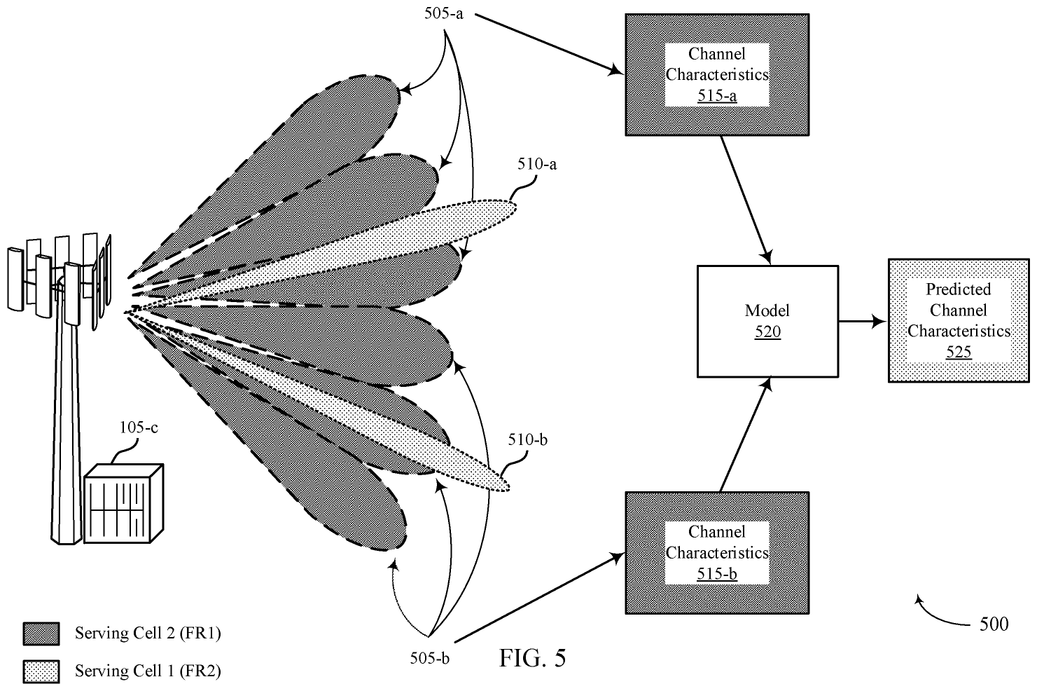

The network entity may configure a model for the UE to predict the channel characteristics (e.g., L1-RSRP/SINR), wherein the input-output connections may be based on any of the linking configurations or associations described herein and as illustrated with respect to CSI report setting 301 or 302, or both as well as FIGS. 4 and 5. An example of a model output may include L1-RSRP predicted for eight SSBs in the second frequency range, which may be separated into two groups, wherein each group contains four SSBs. An example of a model input may include four CSI-RS resources in the first frequency range, wherein a first CSI-RS resource and a third CSI-RS resource may be input to a first set of model inputs to predict L1-RSRP associated with the first group, while a second CSI-RS resource and a fourth CSI-RS resource may be input to a second set of model inputs to predict the L1-RSRP associated with the second SSB group. In some examples, the linking configuration or the association may be configured by the CSI report setting 301 or 302.

FIG. 4 illustrates an example of a wireless communications system 400 that supports channel state information resource configurations for beam prediction in accordance with one or more aspects of the present disclosure. In some examples, wireless communications system 400 may implement aspects of wireless communications systems 100 and/or 200. For instance, wireless communications system 400 includes a network entity 105-b, which may be an example of the corresponding devices described with reference to FIG. 1. The network entity 105-b may support a first serving cell for communications in a second frequency range (e.g., FR2) and a second serving cell for communications in a first frequency range (e.g., FR1).

The network entity 105-b may support a number of communication beams 405 for communications in the first frequency range and may support a number of communication beams 410 for communications in the second frequency range. For communications associated with the first frequency range, a first set of communication beams 405-a may be associated with a first CSI-RS resource indicated by a second CSI resource configuration of the CSI report setting and a second set of communication beams 405-b may be associated with a second CSI-RS resource indicated by the second CSI resource configuration. For communications associated with the second frequency range, a first communication beam 410-a may have an association 415-a with a first CSI-RS resource indicated by a first CSI resource configuration of the CSI report setting and a second communication beam 410-b may have an association 415-b with a second CSI-RS resource indicated by the first CSI resource configuration.

In some examples, a UE (e.g., a UE 115 as described herein) may be configured by a CSI report setting to report one or more predicted channel characteristics (e.g., L1-RSRP, L1-SINR, RI, PMI, CQI) for a first serving cell (e.g., supporting FR2 communications) based on one or more CSI-RS resources for measuring channel characteristics of the second serving cell (e.g., supporting FR1 communications) configured by one or more CSI resource configuration of a CSI report setting (e.g., CSI report setting 301 or 302 as described with reference to FIGS. 3A and 3B). In some examples, the one or more CSI-RS resources for measuring channel characteristics of the second serving cell may be associated with one or more second serving cells. In some examples, predicting the channel characteristics for a first serving cell may be further based on one or more associations 415 or links between resources indicated by the CSI report setting for predicting channel characteristics of the first serving cell and resources indicated by the CSI report setting for measuring channel characteristic of the second serving cell. That is, one or more communication beams associated with the first serving cell may be characterized by measured channel characteristics associated with the communication beams supported by the second serving cell based on one or more associations.

In some examples, the one or more associations 415 may include an association(s) between a group of CSI-RS ports in relation to a second CSI-RS resource of the second serving cell and a CSI-RS port associated a first CSI-RS resource of the first Serving Cell. For example, the UE may determine channel characteristics (e.g., RI, PMI, CQI) associated with communications supported by the first serving cell (e.g., via FR2) based on determining the RI based on channel characteristics estimated or predicted from different groups of CSI-RS ports across different resources indicated by the second CSI resource configuration. In some examples, the channel characteristics may include at least one of PDP, angle of arrival (AoA), explicit channel information for time-division or frequency-division communications, or any combination thereof.

For example, the UE may be configured with two respective resources indicated by the second CSI resource configuration associated with two different serving cells (e.g., supporting FR1 communications. In some examples, each CSI-RS resource may include 16 CSI-RS ports. As an illustrative example, the UE may be further configured by the CSI report setting such that a first group of CSI-RS ports (e.g., CSI-RS ports 1-8 within the first CSI-RS resource indicated by the second CSI resource configuration) may be associated with a first CSI-RS port with respect to a resource indicated by the first CSI resource configuration defined for the first serving cell (e.g., supporting FR2 communications). The example may further include a second group of CSI-RS ports (e.g., CSI-RS ports 9 through 16 within the first CSI-RS resource indicated by the second CSI resource configuration) may be associated with a second CSI-RS port with respect to a resource indicated by the first CSI resource configuration defined for the first serving cell (e.g., supporting FR2 communications). The example may further include a third group of CSI-RS ports (e.g., CSI-RS ports 1 through 8 within the second CSI-RS resource indicated by the second CSI resource configuration) may be associated with a third CSI-RS port with respect to a resource indicated by the first CSI resource configuration defined for the first serving cell (e.g., supporting FR2 communications). The example may further include a fourth group of CSI-RS ports (e.g., CSI-RS ports 9 through 16 within the second CSI-RS resource indicated by the second CSI resource configuration) may be associated with a fourth CSI-RS port with respect to a resource indicated by the first CSI resource configuration defined for the first serving cell (e.g., supporting FR2 communications).

That is, in some examples, the UE may estimate a first, second, third, or fourth PDP or AoA based on the first, second, third, or fourth group of CSI-RS ports. In some examples, the UE may determine an RI associated with the first serving cell based on the first through the fourth estimated PDP or AoA characteristics. The UE may determine one or more PMI components associated with a CSI-RS port associated with a first CSI-RS resource, based on channel characteristics estimated from one or more of the groups of CSI-RS ports associated with a second CSI-RS resource. In some examples, the channel characteristics may include at least one of PDP, AoA, or an explicit channel (e.g., in frequency duplex or time duplex communication systems). In some examples, the UE may determine CQI based on the PMI components determined for the CSI-RS ports within the first CSI-RS resource.

In some examples, the one or more associations 415 may include associations between a group of CSI-RS ports in relation to a CSI-RS resource indicated by a second CSI resource configuration and a polarization associated with the predicted channel characteristics (e.g., L1-RSRP, L1-SINR, RI, PMI, CQI) for the first serving cell.

The UE may determine RI, PMI, or CQI associated with the first serving cell. For example, the UE may determine RI by assuming a first group of CSI-RS ports with respect to a second CSI-RS resource is associated with a first CSI-RS port based on a first polarization for the first CSI-RS resource, and a second group of CSI-RS ports associated with a second CSI-RS resource is associated with a second CSI-RS port based on a second polarization for the first CSI-RS resource. In some examples, the UE may additionally determine PMI & CQI based on some similar procedures as described herein.

In some examples, the one or more associations 415 may include antenna array mechanical information regarding one or more of the resources indicated by the first CSI resource configuration or one or more of the resources indicated by the second CSI resource configuration, or both. For example, the association may be based on a number of antenna elements in each dimension of the antenna array or configuration (e.g., uniform linear array (ULA) or uniform planar array (UPA)), polarization information for each antenna element of an antenna array, an inter-antenna-element distance associated with the antenna array, an elevation angle of the antenna panel, or any combination thereof. In some such examples, the association may be configured by a cell-common configuration for the first serving cell or the second serving cell or may be included in system information.

In some cases, the one or more associations 415 may include associations in relation to a number of antenna elements and a CSI-RS port associated with the resources indicated by the second CSI resource configuration.

The one or more associations 415 between the resources indicated by the first resource configuration and the resources indicated by the second resource configuration may be configured by a CSI report setting (e.g., as described with reference to FIGS. 3A and 3B) or may be configured by one or more of the CSI resource configurations (e.g., CSI resource settings). The one or more associations 415 may be respectively associated with one or more resources indicated by the second resource configuration, or may be associated with a number of CSI-RS ports associated with the resources indicated by the second CSI resource configuration.

FIG. 5 illustrates an example of a wireless communications system 500 that supports channel state information resource configurations for beam prediction in accordance with one or more aspects of the present disclosure. The wireless communications system 500 may implement aspects of wireless communications systems 100, 200, and/or 400. For instance, wireless communications system 500 includes a network entity 105-c, which may be an example of the corresponding devices described with reference to FIG. 1. The network entity 105-c may support a first serving cell for communications in a second frequency range (e.g., FR2) and a second serving cell for communications in a first frequency range (e.g., FR1).

In some examples, a UE (e.g., a UE 115 as described herein) may predict one or more channel characteristics of the first serving cell (E.g., supporting FR2 communications) based on a machine learning model. For example, the UE may be configured with one or multiple machine learning models to predict one or more channel characteristics (e.g., L1-RSRP, L1-SINR, RI, PMI, CQI for the first serving cell. In some examples, one or more inputs for the machine learning model may include or be based on a group of features each estimated based on a respective group of CSI-RS ports according to one or more of the associations described here, associations based on antenna array mechanical information, or associations between a number of antenna elements and a CSI-RS port as described herein, or any combination thereof.

In some examples, one or more outputs for the machine learning model may include or be based on one or more channel characteristics (e.g., L1-RSRP, L1-SINR, RI, PMI, CQI) associated with a first CSI-RS resource (e.g., as indicated by the CSI resource configuration indicating BPR) for the first serving cell. In some examples, different types of association information as described herein (e.g., with reference to FIG. 4) may be associated with different machine learning models. For example, ULA and UPA may be associated with different ML models.

The machine learning model may be a multi-stage model for FR2 CSI-RS port feature extraction. For example, the UE may be configured with a first stage of a machine learning model to extract the feature input as described herein and associated with each group of FR1 CSI-RS ports described with reference to FIG. 4. In some examples, the UE may be further configured with multiple machine learning models. For example, different models may be applied to different groups of CSI-RS ports. In some examples, the UE may use the output of a first stage machine learning model as input for a second stage machine learning model.

Additionally, or alternatively, the UE may perform explicit FR2 CSI-RS port estimation based on one or more machine learning models. For example, an input may be based on analytical features estimated from respective CSI-RS ports associated with the second CSI-RS resource indicated by the second CSI resource configuration (e.g., associated with the second serving cell supporting FR1 communications). For example, the UE may estimate PDP/AoA/explicit-channel for the CSI-RS ports associated with the second CSI-RS resource indicated by the second CSI resource configuration based on the associated group of CSI-RS ports as described herein.

For example, a UE may measure channel characteristics 515-a based on one or more CSI resources associated with a first group of CSI-RS ports (e.g., beams) 505-a and may measure channel characteristics 515-b based on one or more CSI resources associated with a second group of CSI-RS ports (e.g., beams) 505-b. In some examples, the resources for measuring the channel characteristics may be configured by a second CSI resource configuration (e.g., indicating CMR) in a CSI report setting.

The UE may input the channel characteristics 515-a and 515-b into a model 520 (e.g., a machine learning model) which may output one or more predicted channel characteristics 525 for the FR2 communication beams 510-a and 510-b. In some examples, the inputs may be based on any combination of the associations or channel characteristics described herein. In some examples, the group of CSI ports 505-a may be associated with a first FR2 communication beam 510-a and the group of CSI ports 505-b may be associated with a second FR2 communication beam 510-b.

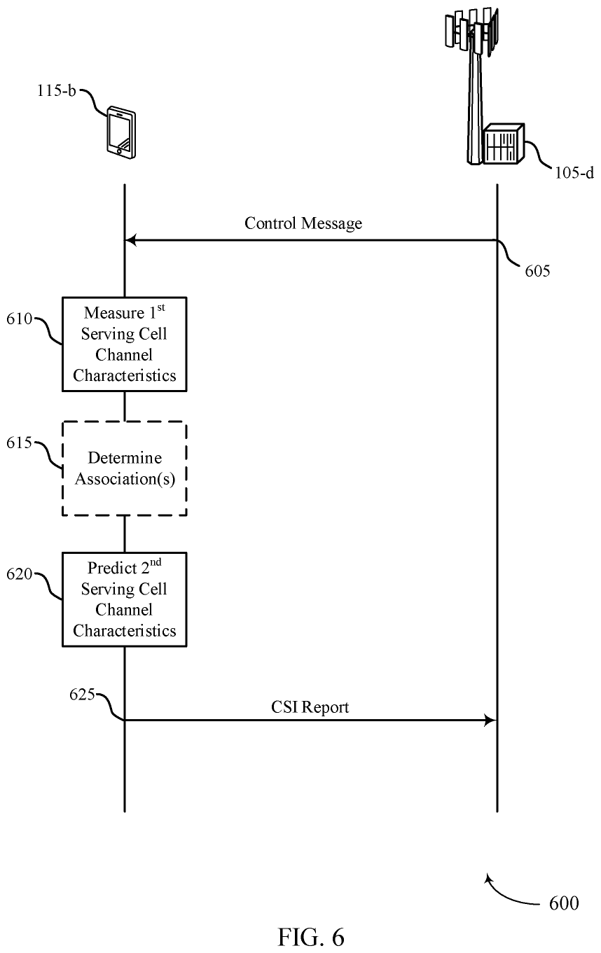

FIG. 6 illustrates an example of a process flow 600 in a system that supports channel state information resource configurations for beam prediction in accordance with one or more aspects of the present disclosure. In some examples, process flow 600 may implement aspects of wireless communications system 100, 200, 400 and/or 500. For example, process flow 600 includes a UE 115-b and a network entity 105-d, which may be examples of the corresponding devices described herein. Additionally, the operations in process flow 600 performed by the UE 115-b and the network entity 105-d may be respectively performed by a UE 115, a network entity 105, or another wireless device, and the example shown should not be construed as limiting.

At 605, the UE 115-b may receive a control message including a CSI report setting. The CSI report setting may include an indication of a first set of resources (e.g., a first CSI resource setting) for channel measurement (e.g., CMR) of communications supported by a first serving cell. The CSI report setting may further include an indication of a second set of resources (e.g., a second CSI resource setting) for beam prediction (e.g., BPR) of one or more communication beams for communications supported by a second serving cell. In some examples, the CSI report setting may be transmitted by one or more aspects of the network entity 105-d supporting the first serving cell (e.g., transmitted via the first frequency range) or may be transmitted by one or more aspects of the network entity 105-d supporting the second serving cell (e.g., transmitted via the second frequency range). In some examples, the first CSI resource setting may be defined within the first frequency range and the second CSI resource setting may be defined within the second frequency range while the CSI report setting may be configured within the first frequency range or the second frequency range. In some examples, the first CSI resource setting indicating the CMR may be referred to as a second CSI resource setting and the second CSI resource setting indicating BPR may be referred to as a first CSI resource setting. As such, the UE 115-b may receive a single CSI report setting for measuring and predicting channel characteristics associated with two or more serving cells supporting two or more frequency ranges.

At 610, the UE 115-b may measure channel characteristics for communication beams of the first serving cell (e.g., supporting communications via the first frequency range) based on one or more CMRs indicated by the first CSI resource setting.

At 615, the UE 115-b may determine one or more associations between the BPR indicated for the second serving cell and the set of CMR indicated for the first serving cell or other channel measurement resources of multiple serving cells.

For example, an association may be between an antenna port associated with a BPR and a set of antenna ports for a CMR. In some examples, an association may be between a polarization associated with the predicted channel characteristics and a group of antenna ports for a CMR. In some examples, an association may be between one or more antenna configurations for the set of BPR, one or more antenna configurations for the set of CMR, or any combination thereof and may be indicated by a cell-common configuration. In some examples, an association may be between a number of antenna elements and an antenna port associated with the BPRs.

At 620, the UE 115-b may predict channel characteristics for communication beams of the second serving cell (e.g., supporting communications via the first frequency range) based on one or more BPR indicated by the second CSI resource setting. In some examples, predicting the channel characteristics associated with the second serving cell may be based on the one or more associations and one or more CMR or the other channel measurement resources, or both.

At 625, the UE 115-a may transmit a CSI report in accordance with the CSI report setting. In some examples, the CSI report may include an indication of the predicted channel characteristics of the second serving cell. In some examples, the UE 115-a may transmit the CSI report via the first frequency range (e.g., associated with the first serving cell) or via the second frequency range (e.g., associated with the second serving cell.

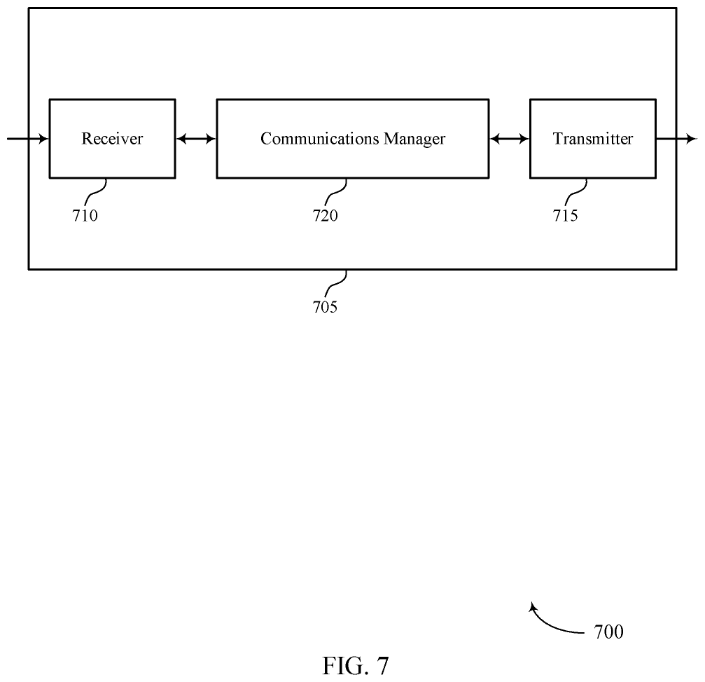

FIG. 7 shows a block diagram 700 of a device 705 that supports channel state information resource configurations for beam prediction in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel state information resource configurations for beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel state information resource configurations for beam prediction). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of channel state information resource configurations for beam prediction as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The communications manager 720 may be configured as or otherwise support a means for measuring first channel characteristics of the first serving cell based on one or more channel measurement resources of the set of channel measurement resources associated with the first CSI resource setting. The communications manager 720 may be configured as or otherwise support a means for predicting, based on measuring the first channel characteristics, second channel characteristics of the second serving cell that are associated with one or more beam prediction resources of the set of beam prediction resources. The communications manager 720 may be configured as or otherwise support a means for transmitting a CSI report in accordance with the CSI report setting, the CSI report including an indication of the second channel characteristics.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources, increased data rates, increased capacity, and increased spectral efficiency, among other examples.

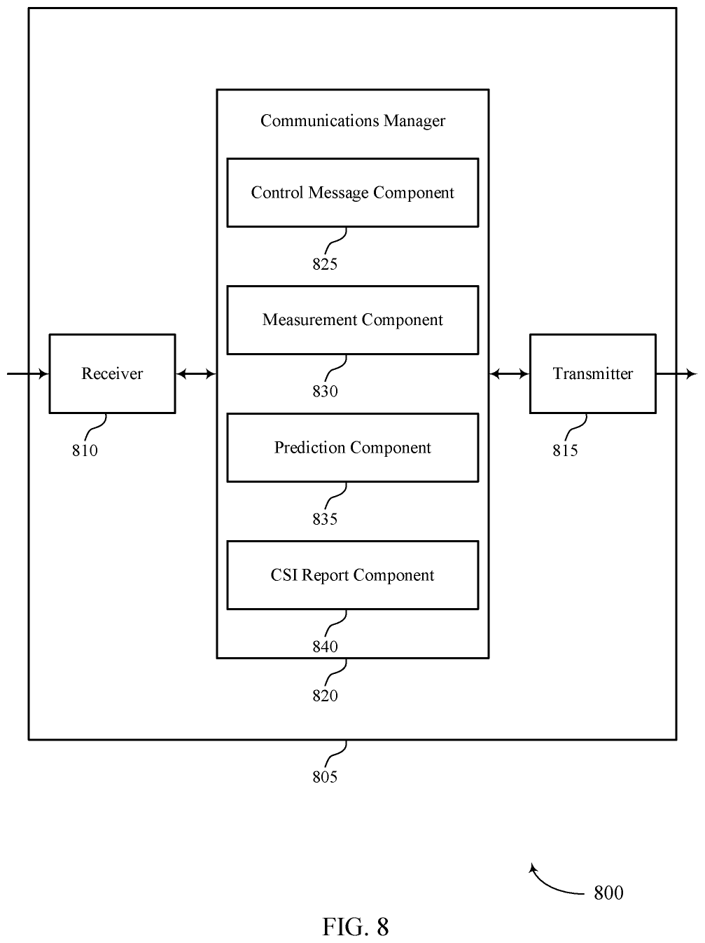

FIG. 8 shows a block diagram 800 of a device 805 that supports channel state information resource configurations for beam prediction in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to channel state information resource configurations for beam prediction). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to channel state information resource configurations for beam prediction). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of channel state information resource configurations for beam prediction as described herein. For example, the communications manager 820 may include a control message component 825, a measurement component 830, a prediction component 835, a CSI report component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control message component 825 may be configured as or otherwise support a means for receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The measurement component 830 may be configured as or otherwise support a means for measuring first channel characteristics of the first serving cell based on one or more channel measurement resources of the set of channel measurement resources associated with the first CSI resource setting. The prediction component 835 may be configured as or otherwise support a means for predicting, based on measuring the first channel characteristics, second channel characteristics of the second serving cell that are associated with one or more beam prediction resources of the set of beam prediction resources. The CSI report component 840 may be configured as or otherwise support a means for transmitting a CSI report in accordance with the CSI report setting, the CSI report including an indication of the second channel characteristics.

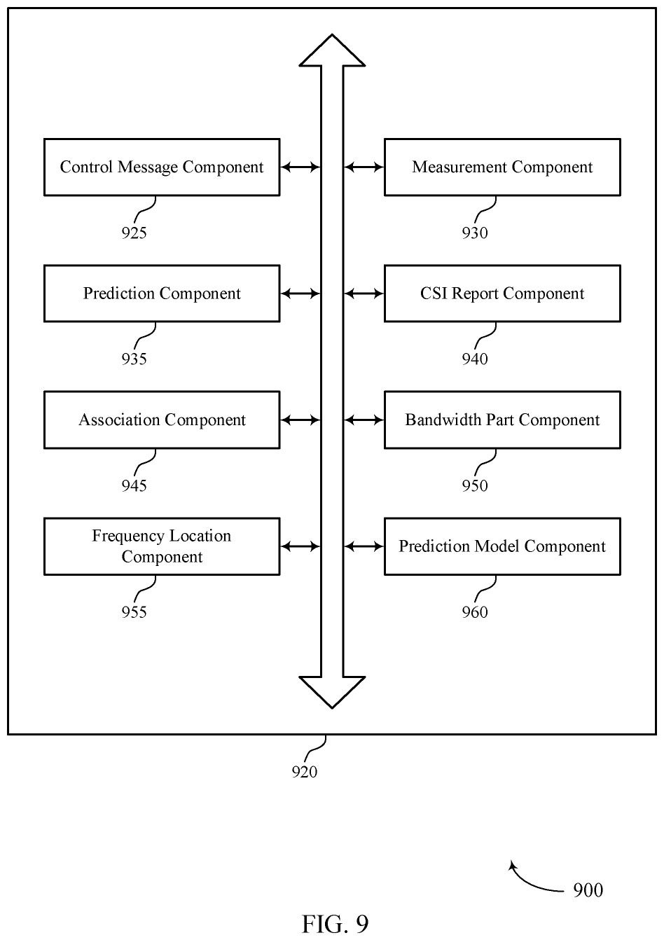

FIG. 9 shows a block diagram 900 of a communications manager 920 that supports channel state information resource configurations for beam prediction in accordance with one or more aspects of the present disclosure. The communications manager 920 may be an example of aspects of a communications manager 720, a communications manager 820, or both, as described herein. The communications manager 920, or various components thereof, may be an example of means for performing various aspects of channel state information resource configurations for beam prediction as described herein. For example, the communications manager 920 may include a control message component 925, a measurement component 930, a prediction component 935, a CSI report component 940, an association component 945, a bandwidth part component 950, a frequency location component 955, a prediction model component 960, or any combination thereof. Each of these components may communicate, directly or indirectly, with one another (e.g., via one or more buses).

The communications manager 920 may support wireless communication at a UE in accordance with examples as disclosed herein. The control message component 925 may be configured as or otherwise support a means for receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The measurement component 930 may be configured as or otherwise support a means for measuring first channel characteristics of the first serving cell based on one or more channel measurement resources of the set of channel measurement resources associated with the first CSI resource setting. The prediction component 935 may be configured as or otherwise support a means for predicting, based on measuring the first channel characteristics, second channel characteristics of the second serving cell that are associated with one or more beam prediction resources of the set of beam prediction resources. The CSI report component 940 may be configured as or otherwise support a means for transmitting a CSI report in accordance with the CSI report setting, the CSI report including an indication of the second channel characteristics.

In some examples, the association component 945 may be configured as or otherwise support a means for determining one or more associations between the set of beam prediction resources of the second serving cell and the set of channel measurement resources of the first serving cell or other channel measurement resources of multiple serving cells, where predicting the second channel characteristics is based on the one or more associations and one or more channel measurement resources from the set of channel measurement resources or the other channel measurement resources, or both.

In some examples, a first association of the one or more associations includes an association between an antenna port associated with a beam prediction resource and a set of antenna ports for a channel measurement resource of the set of channel measurement resources.

In some examples, to support predicting the second channel characteristics, the association component 945 may be configured as or otherwise support a means for determining, based on the first association, respective channel characteristics for each of two or more groups of antenna ports across respective channel measurement resources from the set of channel measurement resources or the other channel measurement resources, or both, where the respective channel characteristics include at least a power delay profile, an angle of arrival, a channel or any combination thereof. In some examples, to support predicting the second channel characteristics, the prediction component 935 may be configured as or otherwise support a means for determining the second channel characteristics of the second serving cell based on the respective channel characteristics of the two or more groups of antenna ports, where the indication of the second channel characteristics includes a rank indicator, a channel quality parameter, a precoding matrix indicator, or any combination thereof.

In some examples, a second association of the one or more associations includes an association between a polarization associated with the second channel characteristics and a group of antenna ports for a channel measurement resource of the set of channel measurement resources.

In some examples, to support predicting the second channel characteristics, the association component 945 may be configured as or otherwise support a means for identifying a first assumption that a first group of antenna ports of a first channel measurement resource from the set of channel measurement resources is associated with a first antenna port based on a first polarization. In some examples, to support predicting the second channel characteristics, the association component 945 may be configured as or otherwise support a means for identifying a second assumption that a second group of antenna ports of a second channel measurement resource from the set of channel measurement resources is associated with a second antenna port based on a second polarization. In some examples, to support predicting the second channel characteristics, the prediction component 935 may be configured as or otherwise support a means for determining the second channel characteristics of the second serving cell based on the first assumption and the second assumption, where the indication of the second channel characteristics includes a rank indicator, a channel quality parameter, a precoding matrix indicator, or any combination thereof.

In some examples, a third association of the one or more associations includes an association between one or more antenna configurations for the set of beam prediction resources, one or more antenna configurations for the set of channel measurement resources, or any combination thereof.

In some examples, to support predicting the second channel characteristics, the association component 945 may be configured as or otherwise support a means for determining the third association based on one or more cell-common configurations.

In some examples, a fourth association of the one or more associations includes an association between a number of antenna elements and an antenna port associated with the set of beam prediction resources.

In some examples, the CSI report setting, the first CSI resource setting, the second CSI resource setting, or any combination thereof, includes an indication of the one or more associations, where determining the one or more associations is based on the indication of the one or more associations. In some examples, each association of the one or more associations is associated with one or more channel measurement resources of the set of channel measurement resources or a number of antenna ports for the set of channel measurement resources.

In some examples, to support predicting the second channel characteristics, the prediction component 935 may be configured as or otherwise support a means for predicting the second channel characteristics based on an output of one or more machine learning algorithms, where an input of the one or more machine learning algorithms includes information that is based on the one or more associations.

In some examples, the one or more machine learning algorithms include a multi-stage machine learning algorithm. In some examples, a first machine learning algorithm of the one or more machine learning algorithms generates an input for a second machine learning algorithm of the one or more machine learning algorithms that predicts the second channel characteristics, an input of the first machine learning algorithm being based on the one or more associations.

In some examples, the input of the one or more machine learning algorithms is based on features estimated from the one or more associations.

In some examples, the control message component 925 may be configured as or otherwise support a means for receiving, within the CSI report setting, an indication of a cell identifier of the second serving cell, where a CSI resource setting identifier for the set of beam prediction resources is associated with a CSI measurement setting of the second serving cell.

In some examples, the control message component 925 may be configured as or otherwise support a means for receiving, within the CSI report setting, an indication of a cell identifier of the first serving cell, where a CSI resource setting identifier for the set of channel measurement resources is associated with a CSI measurement setting of the first serving cell.

In some examples, the bandwidth part component 950 may be configured as or otherwise support a means for determining that a bandwidth part associated with the set of beam prediction resources associated with the second CSI resource setting includes a dormant bandwidth part within the second serving cell, the second channel characteristics being predicted based on the dormant bandwidth part, where the CSI report is transmitted via the first serving cell.

In some examples, the bandwidth part component 950 may be configured as or otherwise support a means for determining that a bandwidth part associated with the set of channel measurement resources associated with the first CSI resource setting includes a dormant bandwidth part within the first serving cell, the first channel characteristics being measured based on the dormant bandwidth part, where the CSI report is transmitted via the second serving cell.

In some examples, the association component 945 may be configured as or otherwise support a means for determining that a first number of resources of the first CSI resource setting are associated with a second number of resources of the second CSI resource setting, where the second channel characteristics are predicted based on the first number of resources.

In some examples, the CSI report setting includes an indication that the first number of resources are associated with the second number of resources. In some examples, the determination is based on the indication that the first number of resources are associated with the second number of resources.

In some examples, the prediction model component 960 may be configured as or otherwise support a means for receiving a message indicating a setting of one or more models for predicting the second channel characteristics, where the one or more models are based on the first number of resources of the first CSI resource setting being associated with the second number of resources of the second CSI resource setting, where predicting the second channel characteristics is based on an output of the one or more models.

In some examples, the frequency location component 955 may be configured as or otherwise support a means for determining a frequency location of a synchronization signal block of the second serving cell based on the second CSI resource setting, where the frequency location of the synchronization signal block is within an active bandwidth part of the second serving cell or outside of the active bandwidth part of the second serving cell.

In some examples, the frequency location component 955 may be configured as or otherwise support a means for determining a frequency location of a synchronization signal block of the first serving cell based on the first CSI resource setting, where the frequency location of the synchronization signal block is within an active bandwidth part of the first serving cell or outside of the active bandwidth part of the first serving cell.

In some examples, to support receiving the control message, the control message component 925 may be configured as or otherwise support a means for receiving the control message indicating the CSI report setting from the first serving cell or from the second serving cell.

In some examples, the indication of the second channel characteristics includes a synchronization signal block resource indicator, a CSI reference signal resource indicator, a reference signal receive power, a single-to-noise ratio, a rank indicator, a channel quality indicator, a precoding matrix indicator, or any combination thereof.

In some examples, the set of channel measurement resources or the set of beam prediction resources, or both, are associated with a set of CSI reference signal resources or a set of synchronization signal block resources, or both.

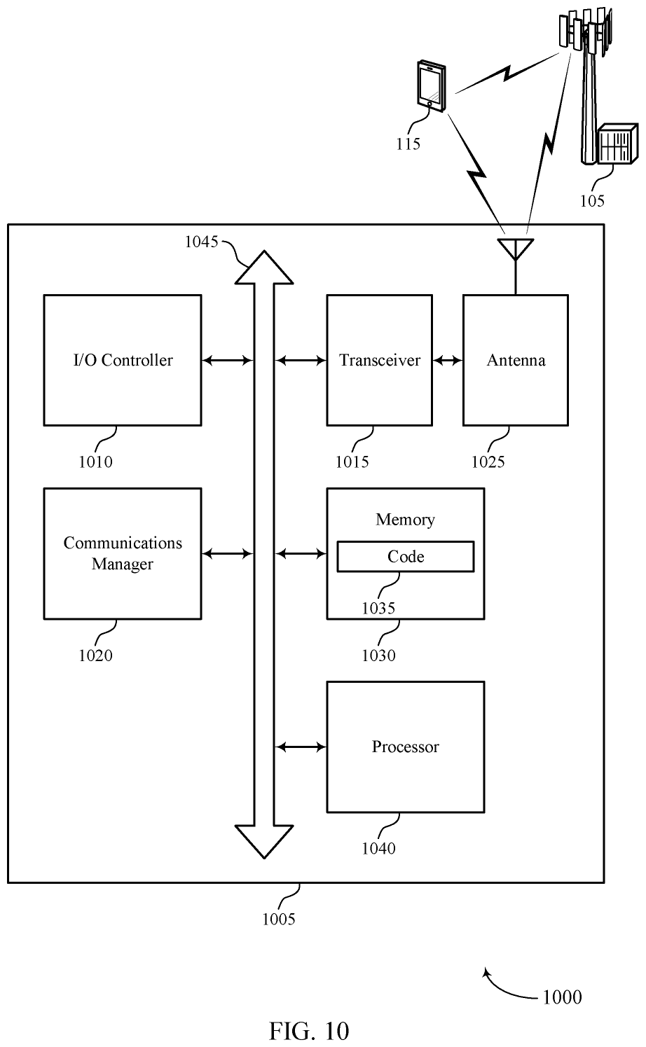

FIG. 10 shows a diagram of a system 1000 including a device 1005 that supports channel state information resource configurations for beam prediction in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting channel state information resource configurations for beam prediction). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The communications manager 1020 may be configured as or otherwise support a means for measuring first channel characteristics of the first serving cell based on one or more channel measurement resources of the set of channel measurement resources associated with the first CSI resource setting. The communications manager 1020 may be configured as or otherwise support a means for predicting, based on measuring the first channel characteristics, second channel characteristics of the second serving cell that are associated with one or more beam prediction resources of the set of beam prediction resources. The communications manager 1020 may be configured as or otherwise support a means for transmitting a CSI report in accordance with the CSI report setting, the CSI report including an indication of the second channel characteristics.

By including or configuring the communications manager 1020 in accordance with examples as described herein, the device 1005 may support techniques for improved communication reliability, more efficient utilization of communication resources, and improved coordination between devices, among other examples.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of channel state information resource configurations for beam prediction as described herein, or the processor 1040 and the memory 1030 may be otherwise configured to perform or support such operations.

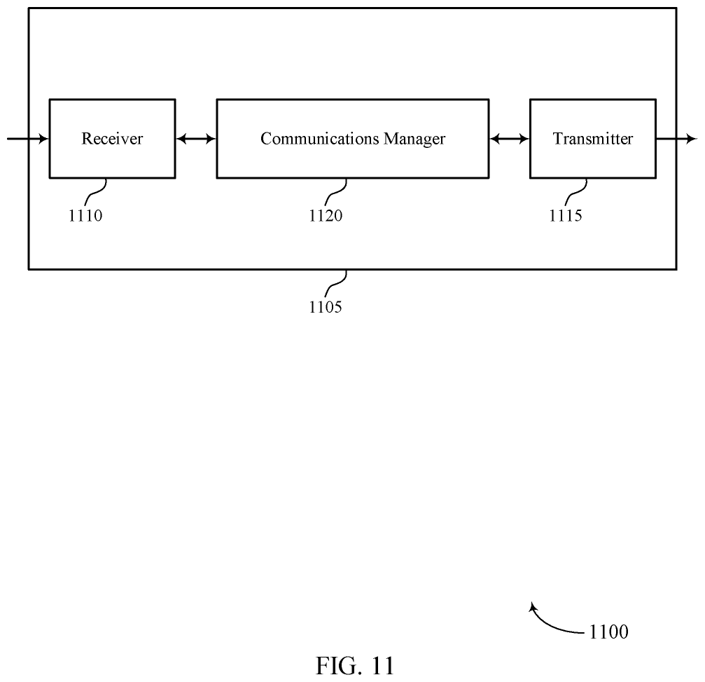

FIG. 11 shows a block diagram 1100 of a device 1105 that supports channel state information resource configurations for beam prediction in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of channel state information resource configurations for beam prediction as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The communications manager 1120 may be configured as or otherwise support a means for receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources, increased data rates, increased capacity, and increased spectral efficiency, among other examples.

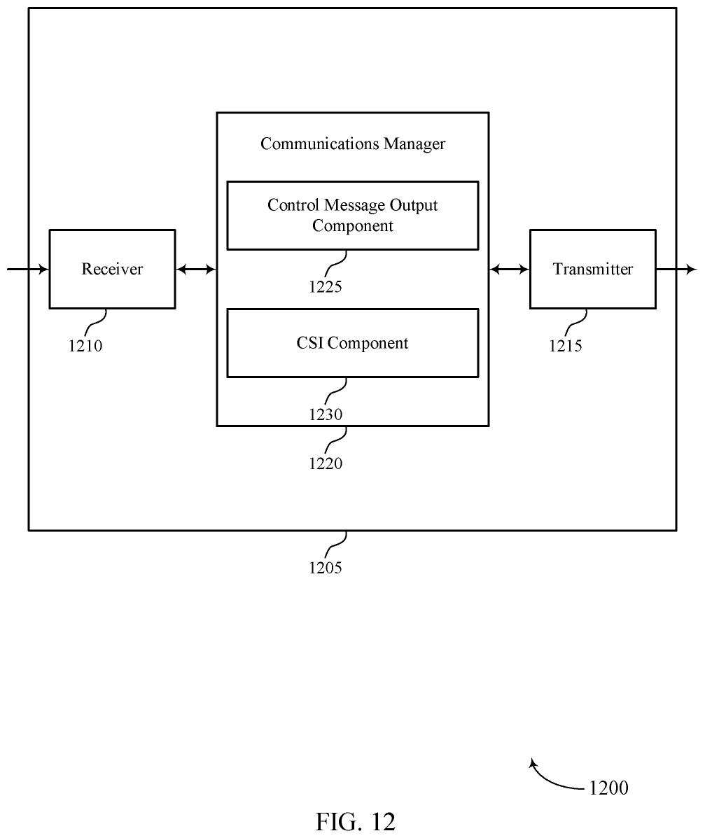

FIG. 12 shows a block diagram 1200 of a device 1205 that supports channel state information resource configurations for beam prediction in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of channel state information resource configurations for beam prediction as described herein. For example, the communications manager 1220 may include a control message output component 1225 a CSI component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control message output component 1225 may be configured as or otherwise support a means for outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The CSI component 1230 may be configured as or otherwise support a means for receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

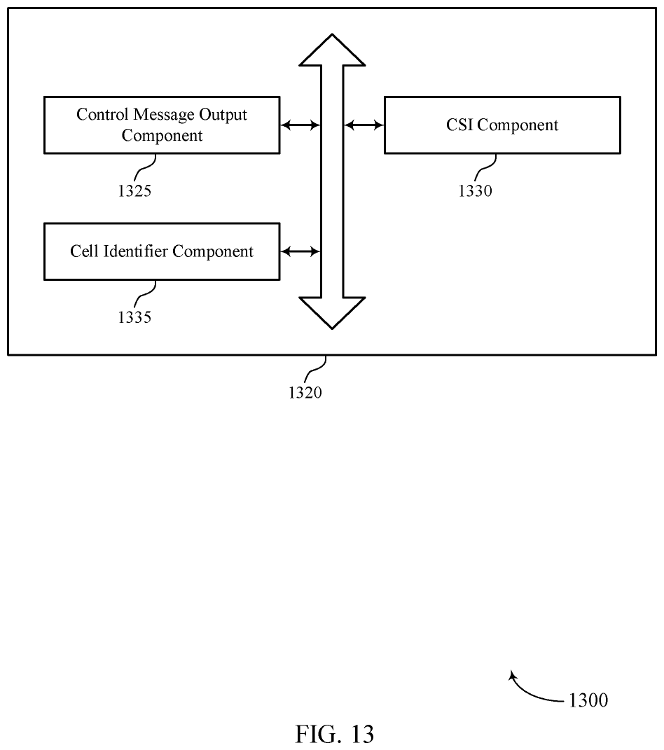

FIG. 13 shows a block diagram 1300 of a communications manager 1320 that supports channel state information resource configurations for beam prediction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of channel state information resource configurations for beam prediction as described herein. For example, the communications manager 1320 may include a control message output component 1325, a CSI component 1330, a cell identifier component 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control message output component 1325 may be configured as or otherwise support a means for outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The CSI component 1330 may be configured as or otherwise support a means for receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

In some examples, the predicted channel characteristics are based on one or more associations between the set of beam prediction resources and the set of channel measurement resources.

In some examples, the cell identifier component 1335 may be configured as or otherwise support a means for outputting, within the CSI report setting, an indication of a cell identifier of the first serving cell or a cell identifier of the second serving cell, where a CSI resource setting identifier for the set of beam prediction resources is associated with a CSI measurement setting of the first serving cell or a CSI measurement setting of the second serving cell.

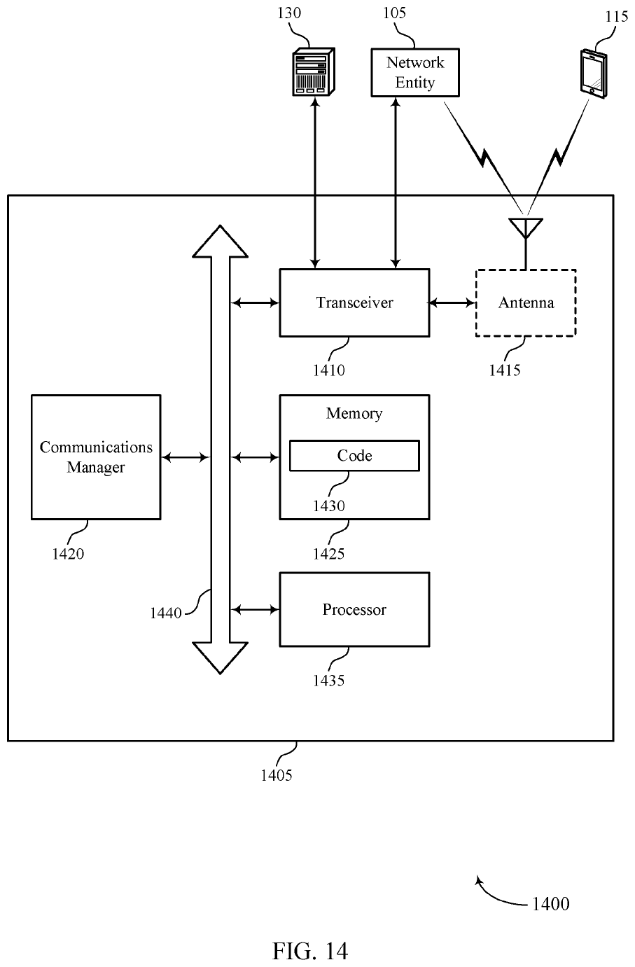

FIG. 14 shows a diagram of a system 1400 including a device 1405 that supports channel state information resource configurations for beam prediction in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting channel state information resource configurations for beam prediction). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The communications manager 1420 may be configured as or otherwise support a means for receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources.

By including or configuring the communications manager 1420 in accordance with examples as described herein, the device 1405 may support techniques for improved communication reliability, more efficient utilization of communication resources, and improved coordination between devices, among other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of channel state information resource configurations for beam prediction as described herein, or the processor 1435 and the memory 1425 may be otherwise configured to perform or support such operations.

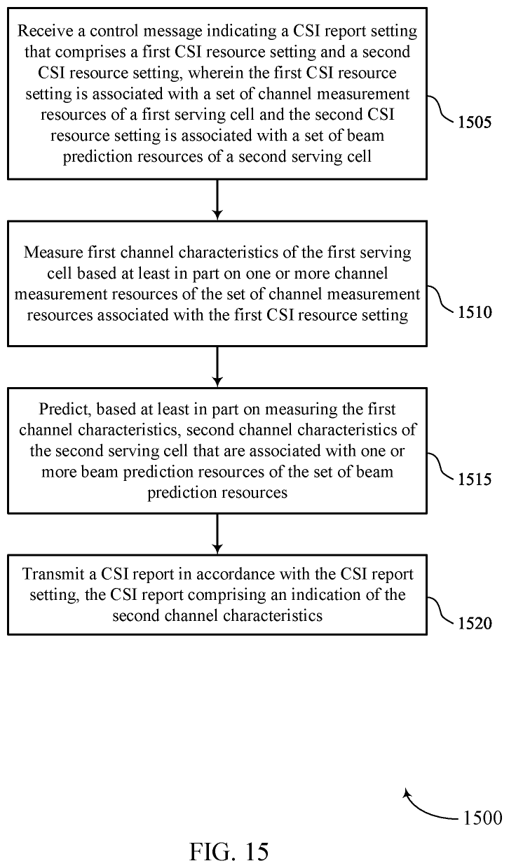

FIG. 15 shows a flowchart illustrating a method 1500 that supports channel state information resource configurations for beam prediction in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The operations of 1505 may be performed in accordance with examples as disclosed herein. In some examples, aspects of the operations of 1505 may be performed by a control message component 925 as described with reference to FIG. 9.

At 1510, the method may include measuring first channel characteristics of the first serving cell based on one or more channel measurement resources of the set of channel measurement resources associated with the first CSI resource setting. The operations of 1510 may be performed in accordance with examples as disclosed herein. In some examples, aspects of the operations of 1510 may be performed by a measurement component 930 as described with reference to FIG. 9.

At 1515, the method may include predicting, based on measuring the first channel characteristics, second channel characteristics of the second serving cell that are associated with one or more beam prediction resources of the set of beam prediction resources. The operations of 1515 may be performed in accordance with examples as disclosed herein. In some examples, aspects of the operations of 1515 may be performed by a prediction component 935 as described with reference to FIG. 9.

At 1520, the method may include transmitting a CSI report in accordance with the CSI report setting, the CSI report including an indication of the second channel characteristics. The operations of 1520 may be performed in accordance with examples as disclosed herein. In some examples, aspects of the operations of 1520 may be performed by a CSI report component 940 as described with reference to FIG. 9.

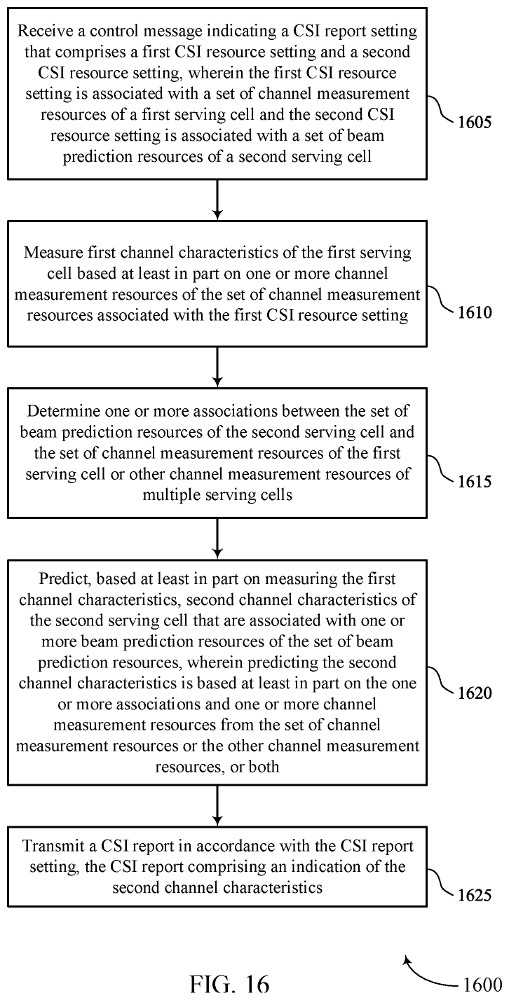

FIG. 16 shows a flowchart illustrating a method 1600 that supports channel state information resource configurations for beam prediction in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The operations of 1605 may be performed in accordance with examples as disclosed herein. In some examples, aspects of the operations of 1605 may be performed by a control message component 925 as described with reference to FIG. 9.

At 1610, the method may include measuring first channel characteristics of the first serving cell based on one or more channel measurement resources of the set of channel measurement resources associated with the first CSI resource setting. The operations of 1610 may be performed in accordance with examples as disclosed herein. In some examples, aspects of the operations of 1610 may be performed by a measurement component 930 as described with reference to FIG. 9.

At 1615, the method may include determining one or more associations between the set of beam prediction resources of the second serving cell and the set of channel measurement resources of the first serving cell or other channel measurement resources of multiple serving cells. The operations of 1615 may be performed in accordance with examples as disclosed herein. In some examples, aspects of the operations of 1615 may be performed by an association component 945 as described with reference to FIG. 9.

At 1620, the method may include predicting, based on measuring the first channel characteristics, second channel characteristics of the second serving cell that are associated with one or more beam prediction resources of the set of beam prediction resources, where predicting the second channel characteristics is based on the one or more associations and one or more channel measurement resources from the set of channel measurement resources or the other channel measurement resources, or both. The operations of 1620 may be performed in accordance with examples as disclosed herein. In some examples, aspects of the operations of 1620 may be performed by a prediction component 935 as described with reference to FIG. 9.

At 1625, the method may include transmitting a CSI report in accordance with the CSI report setting, the CSI report including an indication of the second channel characteristics. The operations of 1625 may be performed in accordance with examples as disclosed herein. In some examples, aspects of the operations of 1625 may be performed by a CSI report component 940 as described with reference to FIG. 9.

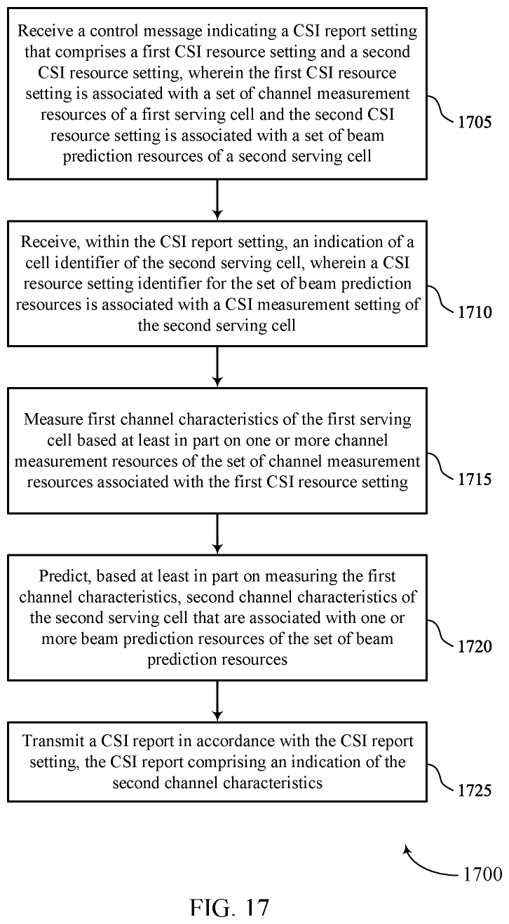

FIG. 17 shows a flowchart illustrating a method 1700 that supports channel state information resource configurations for beam prediction in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The operations of 1705 may be performed in accordance with examples as disclosed herein. In some examples, aspects of the operations of 1705 may be performed by a control message component 925 as described with reference to FIG. 9.

At 1710, the method may include receiving, within the CSI report setting, an indication of a cell identifier of the second serving cell, where a CSI resource setting identifier for the set of beam prediction resources is associated with a CSI measurement setting of the second serving cell. The operations of 1710 may be performed in accordance with examples as disclosed herein. In some examples, aspects of the operations of 1710 may be performed by a control message component 925 as described with reference to FIG. 9.

At 1715, the method may include measuring first channel characteristics of the first serving cell based on one or more channel measurement resources of the set of channel measurement resources associated with the first CSI resource setting. The operations of 1715 may be performed in accordance with examples as disclosed herein. In some examples, aspects of the operations of 1715 may be performed by a measurement component 930 as described with reference to FIG. 9.

At 1720, the method may include predicting, based on measuring the first channel characteristics, second channel characteristics of the second serving cell that are associated with one or more beam prediction resources of the set of beam prediction resources. The operations of 1720 may be performed in accordance with examples as disclosed herein. In some examples, aspects of the operations of 1720 may be performed by a prediction component 935 as described with reference to FIG. 9.

At 1725, the method may include transmitting a CSI report in accordance with the CSI report setting, the CSI report including an indication of the second channel characteristics. The operations of 1725 may be performed in accordance with examples as disclosed herein. In some examples, aspects of the operations of 1725 may be performed by a CSI report component 940 as described with reference to FIG. 9.

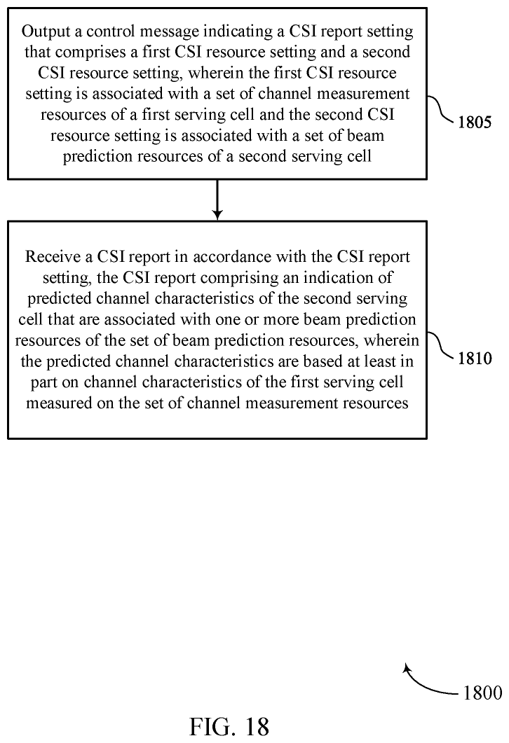

FIG. 18 shows a flowchart illustrating a method 1800 that supports channel state information resource configurations for beam prediction in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The operations of 1805 may be performed in accordance with examples as disclosed herein. In some examples, aspects of the operations of 1805 may be performed by a control message output component 1325 as described with reference to FIG. 13.

At 1810, the method may include receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources. The operations of 1810 may be performed in accordance with examples as disclosed herein. In some examples, aspects of the operations of 1810 may be performed by a CSI component 1330 as described with reference to FIG. 13.

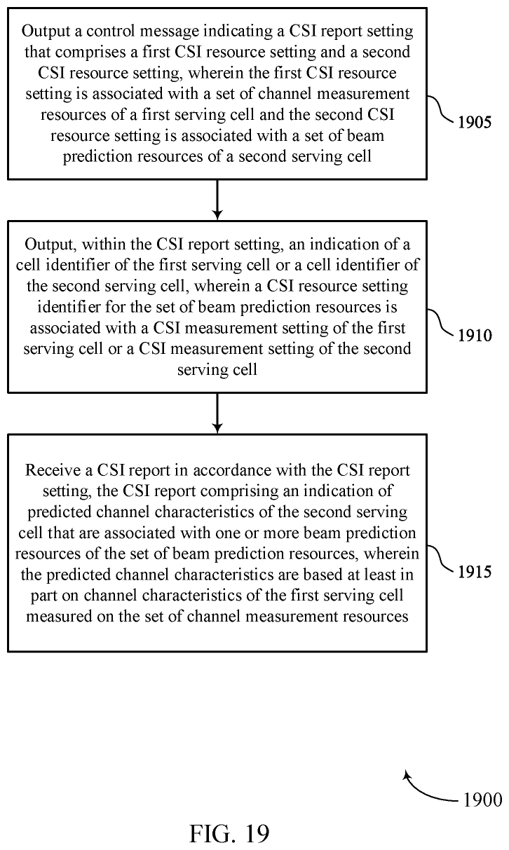

FIG. 19 shows a flowchart illustrating a method 1900 that supports channel state information resource configurations for beam prediction in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include outputting a control message indicating a CSI report setting that includes a first CSI resource setting and a second CSI resource setting, where the first CSI resource setting is associated with a set of channel measurement resources of a first serving cell and the second CSI resource setting is associated with a set of beam prediction resources of a second serving cell. The operations of 1905 may be performed in accordance with examples as disclosed herein. In some examples, aspects of the operations of 1905 may be performed by a control message output component 1325 as described with reference to FIG. 13.

At 1910, the method may include outputting, within the CSI report setting, an indication of a cell identifier of the first serving cell or a cell identifier of the second serving cell, where a CSI resource setting identifier for the set of beam prediction resources is associated with a CSI measurement setting of the first serving cell or a CSI measurement setting of the second serving cell. The operations of 1910 may be performed in accordance with examples as disclosed herein. In some examples, aspects of the operations of 1910 may be performed by a cell identifier component 1335 as described with reference to FIG. 13.

At 1915, the method may include receiving a CSI report in accordance with the CSI report setting, the CSI report including an indication of predicted channel characteristics of the second serving cell that are associated with one or more beam prediction resources of the set of beam prediction resources, where the predicted channel characteristics are based on channel characteristics of the first serving cell measured on the set of channel measurement resources. The operations of 1915 may be performed in accordance with examples as disclosed herein. In some examples, aspects of the operations of 1915 may be performed by a CSI component 1330 as described with reference to FIG. 13.

The following provides an overview of aspects of the present disclosure:

Aspect 1: A method for wireless communication at a UE, comprising: receiving a control message indicating a CSI report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell; measuring first channel characteristics of the first serving cell based at least in part on one or more channel measurement resources of the set of channel measurement resources associated with the first CSI resource setting; predicting, based at least in part on measuring the first channel characteristics, second channel characteristics of the second serving cell that are associated with one or more beam prediction resources of the set of beam prediction resources; and transmitting a CSI report in accordance with the CSI report setting, the CSI report comprising an indication of the second channel characteristics.

Aspect 2: The method of aspect 1, further comprising: determining one or more associations between the set of beam prediction resources of the second serving cell and the set of channel measurement resources of the first serving cell or other channel measurement resources of multiple serving cells, wherein predicting the second channel characteristics is based at least in part on the one or more associations and one or more channel measurement resources from the set of channel measurement resources or the other channel measurement resources, or both.

Aspect 3: The method of aspect 2, wherein a first association of the one or more associations comprises an association between an antenna port associated with a beam prediction resource and a set of antenna ports for a channel measurement resource of the set of channel measurement resources.

Aspect 4: The method of aspect 3, wherein predicting the second channel characteristics comprises: determining, based at least in part on the first association, respective channel characteristics for each of two or more groups of antenna ports across respective channel measurement resources from the set of channel measurement resources or the other channel measurement resources, or both, wherein the respective channel characteristics comprise at least a power delay profile, an angle of arrival, a channel or any combination thereof; and determining the second channel characteristics of the second serving cell based at least in part on the respective channel characteristics of the two or more groups of antenna ports, wherein the indication of the second channel characteristics comprises a rank indicator, a channel quality parameter, a precoding matrix indicator, or any combination thereof.

Aspect 5: The method of any of aspects 2 through 4, wherein a second association of the one or more associations comprises an association between a polarization associated with the second channel characteristics and a group of antenna ports for a channel measurement resource of the set of channel measurement resources.

Aspect 6: The method of aspect 5, wherein predicting the second channel characteristics comprises: identifying a first assumption that a first group of antenna ports of a first channel measurement resource from the set of channel measurement resources is associated with a first antenna port based at least in part on a first polarization; identifying a second assumption that a second group of antenna ports of a second channel measurement resource from the set of channel measurement resources is associated with a second antenna port based at least in part on a second polarization; and determining the second channel characteristics of the second serving cell based at least in part on the first assumption and the second assumption, wherein the indication of the second channel characteristics comprises a rank indicator, a channel quality parameter, a precoding matrix indicator, or any combination thereof.

Aspect 7: The method of any of aspects 2 through 6, wherein a third association of the one or more associations comprises an association between one or more antenna configurations for the set of beam prediction resources, one or more antenna configurations for the set of channel measurement resources, or any combination thereof.

Aspect 8: The method of aspect 7, wherein predicting the second channel characteristics comprises: determining the third association based at least in part on one or more cell-common configurations.

Aspect 9: The method of any of aspects 2 through 8, wherein a fourth association of the one or more associations comprises an association between a number of antenna elements and an antenna port associated with the set of beam prediction resources.

Aspect 10: The method of any of aspects 2 through 9, wherein the CSI report setting, the first CSI resource setting, the second CSI resource setting, or any combination thereof, comprises an indication of the one or more associations, wherein determining the one or more associations is based at least in part on the indication of the one or more associations; and each association of the one or more associations is associated with the one or more channel measurement resources of the set of channel measurement resources or a number of antenna ports for the set of channel measurement resources.

Aspect 11: The method of any of aspects 2 through 10, wherein predicting the second channel characteristics comprises: predicting the second channel characteristics based at least in part on an output of one or more machine learning algorithms, wherein an input of the one or more machine learning algorithms comprises information that is based at least in part on the one or more associations.

Aspect 12: The method of aspect 11, wherein the one or more machine learning algorithms comprise a multi-stage machine learning algorithm, and a first machine learning algorithm of the one or more machine learning algorithms generates an input for a second machine learning algorithm of the one or more machine learning algorithms that predicts the second channel characteristics, an input of the first machine learning algorithm being based at least in part on the one or more associations.

Aspect 13: The method of any of aspects 11 through 12, wherein the input of the one or more machine learning algorithms is based at least in part on features estimated from the one or more associations.

Aspect 14: The method of any of aspects 1 through 13, further comprising: receiving, within the CSI report setting, an indication of a cell identifier of the second serving cell, wherein a CSI resource setting identifier for the set of beam prediction resources is associated with a CSI measurement setting of the second serving cell.

Aspect 15: The method of any of aspects 1 through 14, further comprising: receiving, within the CSI report setting, an indication of a cell identifier of the first serving cell, wherein a CSI resource setting identifier for the set of channel measurement resources is associated with a CSI measurement setting of the first serving cell.

Aspect 16: The method of any of aspects 1 through 15, further comprising: determining that a bandwidth part associated with the set of beam prediction resources associated with the second CSI resource setting comprises a dormant bandwidth part within the second serving cell, the second channel characteristics being predicted based at least in part on the dormant bandwidth part, wherein the CSI report is transmitted via the first serving cell.

Aspect 17: The method of any of aspects 1 through 16, further comprising: determining that a bandwidth part associated with the set of channel measurement resources associated with the first CSI resource setting comprises a dormant bandwidth part within the first serving cell, the first channel characteristics being measured based at least in part on the dormant bandwidth part, wherein the CSI report is transmitted via the second serving cell.

Aspect 18: The method of any of aspects 1 through 17, further comprising: determining that a first number of resources of the first CSI resource setting are associated with a second number of resources of the second CSI resource setting, wherein the second channel characteristics are predicted based at least in part on the first number of resources.

Aspect 19: The method of aspect 18, wherein the CSI report setting comprises an indication that the first number of resources are associated with the second number of resources, and the determination is based at least in part on the indication that the first number of resources are associated with the second number of resources.

Aspect 20: The method of any of aspects 18 through 19, further comprising: receiving a message indicating a setting of one or more models for predicting the second channel characteristics, wherein the one or more models are based at least in part on the first number of resources of the first CSI resource setting being associated with the second number of resources of the second CSI resource setting, wherein predicting the second channel characteristics is based at least in part on an output of the one or more models.

Aspect 21: The method of any of aspects 1 through 20, further comprising: determining a frequency location of a synchronization signal block of the second serving cell based at least in part on the second CSI resource setting, wherein the frequency location of the synchronization signal block is within an active bandwidth part of the second serving cell or outside of the active bandwidth part of the second serving cell.

Aspect 22: The method of any of aspects 1 through 21, further comprising: determining a frequency location of a synchronization signal block of the first serving cell based at least in part on the first CSI resource setting, wherein the frequency location of the synchronization signal block is within an active bandwidth part of the first serving cell or outside of the active bandwidth part of the first serving cell.

Aspect 23: The method of any of aspects 1 through 22, wherein receiving the control message comprises: receiving the control message indicating the CSI report setting from the first serving cell or from the second serving cell.

Aspect 24: The method of any of aspects 1 through 23, wherein the indication of the second channel characteristics comprises a synchronization signal block resource indicator, a CSI reference signal resource indicator, a reference signal receive power, a single-to-noise ratio, a rank indicator, a channel quality indicator, a precoding matrix indicator, or any combination thereof.

Aspect 25: The method of any of aspects 1 through 24, wherein the set of channel measurement resources or the set of beam prediction resources, or both, are associated with a set of CSI reference signal resources or a set of synchronization signal block resources, or both.

Aspect 26: A method for wireless communication at a network entity, comprising: outputting a control message indicating a CSI report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell; and receiving a CSI report in accordance with the CSI report setting, the CSI report comprising an indication of predicted channel characteristics of the second serving cell that are associated with one or more beam prediction resources of the set of beam prediction resources, wherein the predicted channel characteristics are based at least in part on channel characteristics of the first serving cell measured on the set of channel measurement resources.

Aspect 27: The method of aspect 26, wherein the predicted channel characteristics are based at least in part on one or more associations between the set of beam prediction resources and the set of channel measurement resources.

Aspect 28: The method of any of aspects 26 through 27, further comprising: outputting, within the CSI report setting, an indication of a cell identifier of the first serving cell or a cell identifier of the second serving cell, wherein a CSI resource setting identifier for the set of beam prediction resources is associated with a CSI measurement setting of the first serving cell or a CSI measurement setting of the second serving cell.

Aspect 29: An apparatus for wireless communication at a UE, comprising a processor; memory coupled with the processor; and instructions stored in the memory and executable by the processor to cause the apparatus to perform a method of any of aspects 1 through 25.

Aspect 30: An apparatus for wireless communication at a UE, comprising at least one means for performing a method of any of aspects 1 through 25.

Aspect 31: A non-transitory computer-readable medium storing code for wireless communication at a UE, the code comprising instructions executable by a processor to perform a method of any of aspects 1 through 25.

Aspect 32: An apparatus for wireless communication at a network entity, comprising a processor; memory coupled with the processor; and instructions stored in the memory and executable by the processor to cause the apparatus to perform a method of any of aspects 26 through 28.

Aspect 33: An apparatus for wireless communication at a network entity, comprising at least one means for performing a method of any of aspects 26 through 28.

Aspect 34: A non-transitory computer-readable medium storing code for wireless communication at a network entity, the code comprising instructions executable by a processor to perform a method of any of aspects 26 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a control message indicating a channel state information (CSI) report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell;
measuring first channel characteristics of the first serving cell based at least in part on one or more channel measurement resources of the set of channel measurement resources associated with the first CSI resource setting;
predicting, based at least in part on measuring the first channel characteristics, second channel characteristics of the second serving cell that are associated with one or more beam prediction resources of the set of beam prediction resources; and
transmitting a CSI report in accordance with the CSI report setting, the CSI report comprising an indication of the second channel characteristics.

2. The method of claim 1, further comprising:
determining one or more associations between the set of beam prediction resources of the second serving cell and the set of channel measurement resources of the first serving cell or other channel measurement resources of multiple serving cells, wherein predicting the second channel characteristics is based at least in part on the one or more associations and one or more channel measurement resources from the set of channel measurement resources or the other channel measurement resources, or both.

3. The method of claim 2, wherein a first association of the one or more associations comprises an association between an antenna port associated with a beam prediction resource and a set of antenna ports for a channel measurement resource of the set of channel measurement resources.

4. The method of claim 3, wherein predicting the second channel characteristics comprises:
determining, based at least in part on the first association, respective channel characteristics for each of two or more groups of antenna ports across respective channel measurement resources from the set of channel measurement resources or the other channel measurement resources, or both, wherein the respective channel characteristics comprise at least a power delay profile, an angle of arrival, a channel or any combination thereof; and
determining the second channel characteristics of the second serving cell based at least in part on the respective channel characteristics of the two or more groups of antenna ports, wherein the indication of the second channel characteristics comprises a rank indicator, a channel quality parameter, a precoding matrix indicator, or any combination thereof.

5. The method of claim 2, wherein a second association of the one or more associations comprises an association between a polarization associated with the second channel characteristics and a group of antenna ports for a channel measurement resource of the set of channel measurement resources.

6. The method of claim 5, wherein predicting the second channel characteristics comprises:
identifying a first assumption that a first group of antenna ports of a first channel measurement resource from the set of channel measurement resources is associated with a first antenna port based at least in part on a first polarization;
identifying a second assumption that a second group of antenna ports of a second channel measurement resource from the set of channel measurement resources is associated with a second antenna port based at least in part on a second polarization; and
determining the second channel characteristics of the second serving cell based at least in part on the first assumption and the second assumption, wherein the indication of the second channel characteristics comprises a rank indicator, a channel quality parameter, a precoding matrix indicator, or any combination thereof.

7. The method of claim 2, wherein a third association of the one or more associations comprises an association between one or more antenna configurations for the set of beam prediction resources, one or more antenna configurations for the set of channel measurement resources, or any combination thereof.

8. The method of claim 7, wherein predicting the second channel characteristics comprises:
determining the third association based at least in part on one or more cell-common configurations.

9. The method of claim 2, wherein a fourth association of the one or more associations comprises an association between a number of antenna elements and an antenna port associated with the set of beam prediction resources.

10. The method of claim 2, wherein:
the CSI report setting, the first CSI resource setting, the second CSI resource setting, or any combination thereof, comprises an indication of the one or more associations, wherein determining the one or more associations is based at least in part on the indication of the one or more associations; and
each association of the one or more associations is associated with the one or more channel measurement resources of the set of channel measurement resources or a number of antenna ports for the set of channel measurement resources.

11. The method of claim 2, wherein predicting the second channel characteristics comprises:
predicting the second channel characteristics based at least in part on an output of one or more machine learning algorithms, wherein an input of the one or more machine learning algorithms comprises information that is based at least in part on the one or more associations.

12. The method of claim 11, wherein:
the one or more machine learning algorithms comprise a multi-stage machine learning algorithm, and
a first machine learning algorithm of the one or more machine learning algorithms generates an input for a second machine learning algorithm of the one or more machine learning algorithms that predicts the second channel characteristics, an input of the first machine learning algorithm being based at least in part on the one or more associations.

13. The method of claim 11, wherein the input of the one or more machine learning algorithms is based at least in part on features estimated from the one or more associations.

14. The method of claim 1, further comprising:
receiving, within the CSI report setting, an indication of a cell identifier of the second serving cell, wherein a CSI resource setting identifier for the set of beam prediction resources is associated with a CSI measurement setting of the second serving cell.

15. The method of claim 1, further comprising:
receiving, within the CSI report setting, an indication of a cell identifier of the first serving cell, wherein a CSI resource setting identifier for the set of channel measurement resources is associated with a CSI measurement setting of the first serving cell.

16. The method of claim 1, further comprising:
determining that a bandwidth part associated with the set of beam prediction resources associated with the second CSI resource setting comprises a dormant bandwidth part within the second serving cell, the second channel characteristics being predicted based at least in part on the dormant bandwidth part, wherein the CSI report is transmitted via the first serving cell.

17. The method of claim 1, further comprising:
determining that a bandwidth part associated with the set of channel measurement resources associated with the first CSI resource setting comprises a dormant bandwidth part within the first serving cell, the first channel characteristics being measured based at least in part on the dormant bandwidth part, wherein the CSI report is transmitted via the second serving cell.

18. The method of claim 1, further comprising:
determining that a first number of resources of the first CSI resource setting are associated with a second number of resources of the second CSI resource setting, wherein the second channel characteristics are predicted based at least in part on the first number of resources.

19. The method of claim 18, wherein:
the CSI report setting comprises an indication that the first number of resources are associated with the second number of resources, and
the determination is based at least in part on the indication that the first number of resources are associated with the second number of resources.

20. The method of claim 18, further comprising:
receiving a message indicating a setting of one or more models for predicting the second channel characteristics, wherein the one or more models are based at least in part on the first number of resources of the first CSI resource setting being associated with the second number of resources of the second CSI resource setting, wherein predicting the second channel characteristics is based at least in part on an output of the one or more models.

21. The method of claim 1, further comprising:
determining a frequency location of a synchronization signal block of the second serving cell based at least in part on the second CSI resource setting, wherein the frequency location of the synchronization signal block is within an active bandwidth part of the second serving cell or outside of the active bandwidth part of the second serving cell.

22. The method of claim 1, further comprising:
determining a frequency location of a synchronization signal block of the first serving cell based at least in part on the first CSI resource setting, wherein the frequency location of the synchronization signal block is within an active bandwidth part of the first serving cell or outside of the active bandwidth part of the first serving cell.

23. The method of claim 1, wherein receiving the control message comprises:
receiving the control message indicating the CSI report setting from the first serving cell or from the second serving cell.

24. The method of claim 1, wherein the indication of the second channel characteristics comprises a synchronization signal block resource indicator, a CSI reference signal resource indicator, a reference signal receive power, a single-to-noise ratio, a rank indicator, a channel quality indicator, a precoding matrix indicator, or any combination thereof.

25. The method of claim 1, wherein the set of channel measurement resources or the set of beam prediction resources, or both, are associated with a set of CSI reference signal resources or a set of synchronization signal block resources, or both.

26. A method for wireless communication at a network entity, comprising:
outputting a control message indicating a channel state information (CSI) report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell; and
receiving a CSI report in accordance with the CSI report setting, the CSI report comprising an indication of predicted channel characteristics of the second serving cell that are associated with one or more beam prediction resources of the set of beam prediction resources, wherein the predicted channel characteristics are based at least in part on channel characteristics of the first serving cell measured on the set of channel measurement resources.

27. The method of claim 26, wherein the predicted channel characteristics are based at least in part on one or more associations between the set of beam prediction resources and the set of channel measurement resources.

28. The method of claim 26, further comprising:
outputting, within the CSI report setting, an indication of a cell identifier of the first serving cell or a cell identifier of the second serving cell, wherein a CSI resource setting identifier for the set of beam prediction resources is associated with a CSI measurement setting of the first serving cell or a CSI measurement setting of the second serving cell.

29. An apparatus for wireless communication at a user equipment (UE), comprising:
a processor;
memory coupled with the processor; and
instructions stored in the memory and executable by the processor to cause the apparatus to:
receive a control message indicating a channel state information (CSI) report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell;
measure first channel characteristics of the first serving cell based at least in part on one or more channel measurement resources of the set of channel measurement resources associated with the first CSI resource setting;
predict, based at least in part on measuring the first channel characteristics, second channel characteristics of the second serving cell that are associated with one or more beam prediction resources of the set of beam prediction resources; and
transmit a CSI report in accordance with the CSI report setting, the CSI report comprising an indication of the second channel characteristics.

30. An apparatus for wireless communication at a network entity, comprising:
a processor;
memory coupled with the processor; and
instructions stored in the memory and executable by the processor to cause the apparatus to:
output a control message indicating a channel state information (CSI) report setting that comprises a first CSI resource setting and a second CSI resource setting, wherein the first CSI resource setting is associated with a set of channel measurement resources of a first serving cell and the second CSI resource setting is associated with a set of beam prediction resources of a second serving cell; and
receive a CSI report in accordance with the CSI report setting, the CSI report comprising an indication of predicted channel characteristics of the second serving cell that are associated with one or more beam prediction resources of the set of beam prediction resources, wherein the predicted channel characteristics are based at least in part on channel characteristics of the first serving cell measured on the set of channel measurement resources.
